(19) United States
(12) Patent Application Publication
(10) Pub. No.: US 2006/0010009 A1
(43) Pub. Date: Jan. 12, 2006

(54) Medication card and system

(76) Inventor: William L. Fangman, Durham, NC (US)

Correspondence Address: MILLER, EVERMAN & BERNARD, PLLC, 4701 HEDGEMORE DR., SUITE 2500, CHARLOTTE, NC, 28209, US

(21) Appl. No.: 10/886,394

(22) Filed: Jul. 7, 2004

(51) Int. Cl. G06Q 10/00

(52) U.S. Cl. 705/2

(57) ABSTRACT

A globally-accessible computerized system for data management of medications for a plurality of patients. The system allows for medication specific data of the patient to be stored and modified such as the name of the medication, an image of the medication, the form of the medication, the route of administration, the frequency at which the medication is to be taken, the purpose of the medication and any particular instructions from the healthcare provider regarding the medication. By means of the system, the patient may maintain a comprehensive list of current medications in order to aid the healthcare provider in diagnosis and thereby reduce the risk of an adverse drug event. The system also allows for the patient to make a prescription request to the healthcare provider and for the health care provider to submit the prescription to a pharmacist for filling.

### BACKGROUND OF THE INVENTION

1. Field of the Invention

The present invention relates generally to the field of medication and, more specifically, to an electronic system for use in data management relating to a patient's medications and for prescribing medication.

2. Description of the Related Art

Adverse drug events are medical situations where an error in prescribed and/or administered medication results in a negative physical reaction by the patient. Such medication errors have caused allergic reactions, severe illness, permanent disability and even death in patients. In addition to causing physical and emotional suffering to patients, adverse drug events are financially costly to hospitals and physicians who might voluntarily cover the cost of the mistake or pass the costs on to patients or insurance companies. Adverse drug events may also subject the physician to professional liability.

Notwithstanding the significance of adverse drug events, the current system of managing a patient's medication information, and prescribing and dispensing pharmaceuticals, often results in inefficient data management, inaccurate prescriptions and improper dispensing of medications.

Moreover, medication errors may occur at any time during the patient treatment process, from the physician's initial prescription order, to transcription, to dispensing, and finally to the administration of the medication. These errors may occur due to a mistake by the physician, pharmacist or patient during the treatment process.

For example, physician error may occur due to incorrect dosing on a prescription, incorrect frequency or route, or prescribing a medication to which the patient has a known allergy. Poor handwriting may also lead to errors. Unfortunately, in today's medical offices, there is limited time to double check allergy information, drug interactions, prescription information and the patient's understanding of the treatment plan.

Failure or inability of the treating physician to obtain a current and comprehensive listing of a patient's medications may also lead to an adverse drug event. For example, complete patient-specific information which is directly relevant to treatment management for the subject patient is frequently unavailable to the treating physician. Moreover, correspondence between different treating physicians is not always timely and accurate. Often a note is not sent to the consulting or referring physician. And, even if a note is sent, it may not contain the medication changes or the note may arrive after the patient has presented to the referred doctor. The patient often is of little assistance as he may not recall the name or dose of the new medication that was started by the referring physician.

The above identified problem is accentuated in an acute setting such as during hospitalization, an acute care clinic visit or an emergency room visit. For example, while the patient may be properly treated for the condition presented, the physician may not be aware that there are previous medications that need to be continued. Currently, substantial time is spent in the emergency room looking through prior charts, calling nursing homes, calling family members and looking through sacks of medicine to determine what medications the patient is currently using.

Polypharmacy also acerbates the problem of tracking, dosing and prescribing medication to patients. For example, a patient may present to a physician for a perceived ailment that is actually a caused side-effect of another medication. Without having knowledge of the patient's current medication usage, there is no way for the physician to correctly treat the patient. And, even with knowledge of the patient's medications, it is time consuming to research whether a certain symptom may be a medication side-effect.

Medication errors also occur since patients often have difficulty following their treatment plan. For example, patients may have difficultly in understanding the “foreign language” of medication names and doses. This problem is exacerbated in that physicians have limited time to thoroughly explain the purpose and application of each medication. It is also common for patients, even those without cognitive decline, to forget information and instructions regarding treatment after presenting to a physician. This is further problematic in that prescriptions include very limited instructions and that there are not any written instructions regarding previous medications. For example, it would be beneficial if instructions were provided on the prescription or otherwise available to remind a patient to discontinue his use of a previous medication, or that the new medication replaces a previous medication, or other additional instructions. Currently, upon leaving the doctor's office, there is no simple way for a patient to refresh his memory regarding medication usage or to learn more about his medications.

Patients also find frustrating the amount of time that is spent in obtaining prescriptions. First, a large portion of a doctor's visit is spent trying to determine the patient's current medications, instead of being used for diagnosis, treatment and explanation. Then, the patient often has to wait at the pharmacy while his prescription is being filled, instead of being ready for pick-up by the time the patient gets to the pharmacy.

The wait at the pharmacy is often due to the long delay in time before the physician calls-in the prescription. Physicians and their staff, being inundated with refill requests from patients and pharmacies, typically do not have the time to immediately call the pharmacy, listen to the automated system and “call in” the prescription.

Prior art FIG. 1 illustrates a conventional process 10 for prescription writing. First, the physician determines what medications the patient is currently taking 12. Then the physician develops a treatment plan 14 for the patient. The physician may also consider in the treatment plan potential drug interactions and/or patient's allergies that are known to him or the patient or in the records. Where the treatment plan includes a new medication, a prescription is handwritten 16 under the physician's signature, usually on a prescription pad. The prescription bears the patient's identification, the physician's signature, the date and possibly an advisory regarding contraindications. The patient takes the prescription to the pharmacy 18 and waits for the prescription to be filled 20. The doctor's orders are written in the prescription bottle 22 and the patient beings taking the medication 24.

Currently, prescription refill requests are personally time consuming for the physician and pharmacist and for their respective staff, particularly in view of the large number of requests made each day. Prior art FIG. 2 illustrates a conventional prescription refill process 24 wherein the patient phones-in a refill request to the pharmacy 26, navigating through an automated system. Pharmacy personnel take the refill request and, when no addition refill is provided for, contacts the doctor's office for approval 28. A receptionist at doctor's office takes the refill request 30. At some point in the day, the physician reviews the requests and decides whether to accept or deny the request 32. Typically, the physician doesn't have time for conducting reviews except over lunch or after the day's last patient. The physician or nurse obtains the pharmacy number, places the call 34, navigates through a series of automated options, then waits for the pharmacist to answer, or, where there is no answer, the physician can dictate the prescription request. Once the prescription is filled, the patient is notified 36 of the same, typically by a pre-recorded telephone message. Thereafter, the patient picks-up the medication at the pharmacy 37 and begins his treatment 38.

Many adverse drug events could be prevented by allowing a physician to quickly review a patient's medications and look-up possible medication side-effects. Likewise, adverse drug events could also be reduced by providing an integrated data management system whereby patients could refresh their memory as to the name, purpose, dosage, side-effects and other pertinent information with respect to their medications.

Adverse drug effects could be further reduced by limiting the number of handwritten prescriptions in favor of computer generated prescriptions. It has been found that handwritten prescriptions contain errors in significantly greater number than prescriptions entered into a computer or typed.

Accordingly, what is needed is for a medication system that reduces the above-identified contributing factors to adverse drug events. Additionally, there is a need for a medication system that allows for a patient to manage his medication information. There is also a need for a medication system that allows for efficient retrieval of a patient's medication history. Moreover, there is also a need for a centralized medication system that allows for effective communication between a patient, healthcare provider and pharmacist, including the capability of requesting and submitting prescriptions. There is yet a further need for a medication system that reduces the amount of time required by a physician and pharmacist in communicating a prescription.

### BRIEF SUMMARY OF THE INVENTION

To achieve the foregoing and other objects, the present invention, as embodied and broadly described herein, provides various embodiments of methods for data management of a patient's medications. In specific embodiments, a method utilizing a globally-accessible computerized system to store a patient's medication data in order to aid a healthcare provider in obtaining a comprehensive list of the patient's medications and to facilitate the patient in being actively engaged in his medication management.

In a preferred embodiment of the present invention, the computerized method for data management of a patent's medications includes the steps of providing a computerized system; storing the classification of a user within the computerized system, such as whether the user is a patient, healthcare provider or pharmacist; storing the name of a medication within the computerized system; allowing the medication name to be changed by the patient; and allowing the patient to make a request for the healthcare provider to prepare a prescription. Optionally, the healthcare provider may use the system to prepare a prescription. As another option, the physician may use the system to electronically submit a prescription to a pharmacy. As yet another option, other various data may be stored within the system such as the frequency at which the medication is to be taken, the route of administration and the purpose of the medication. Meta-data may be attached to any of the data so that the data may be searched for and identified. It is contemplated that a particular advertisement may be associated with identified data in order to have the advertisement displayed on the computer screen of the corresponding user.

In a preferred embodiment, the system is accessible by use of a medication card. Also, it is preferred that the system be web-based so that it is globally accessible.

In a preferred embodiment, a computerized system for data management of a patient's medications is provided and includes a data storage device for storing a patient's medication data. The data may include the name of the medication, the form of the medication, the route of medication administration, the purpose of the medication, contact information of the patient's healthcare provider and contract information of the patient's pharmacist. The patient may change the medication data and enter new data into the system. The system is also configured to allow a patient to electronically submit a request to the healthcare provide for a prescription. The system is further configured to allow the healthcare provider to electronically prepare and submit a prescription to the pharmacist. It is preferred that a medication card be provided for accessing the system.

### BRIEF DESCRIPTION OF THE DRAWINGS

The above described and other features, aspects, and advantages of the present invention are better understood when the following detailed description of the invention is read with reference to the accompanying drawings, wherein:

FIG. 1 is a flowchart illustrating a prior art process for prescription writing and filling;

FIG. 2 is a flowchart illustrating a prior art process for refilling a prescription;

FIG. 3 is a schematic diagram of the invented, globally-accessible, medication system for data management of medications for a plurality of patients;

FIG. 4 is a computer display of a first login webpage for a user to access the medication system;

FIG. 5 is a computer display of a second login webpage for a healthcare provider or a pharmacist to access additional features of the medication system;

FIG. 6 is a computer display of a patient's medication webpage within the medication system wherein the patient's medications are listed and information regarding the medications may be accessed;

FIG. 7 is a computer display of a patient's preferences page for entering contact information regarding the patient's pharmacy and healthcare provider into the medication system;

FIG. 8 is a computer display of a webpage for entering the name of a patient's medication into the medication system;

FIG. 9 is a computer display of a webpage for entering a picture of a patient's medication into the medication system;

FIG. 10 is a computer display of a webpage for entering the form of a patient's medication into the medication system;

FIG. 11 is a computer display of a webpage for entering the route of administration of a patient's medication into the medication system;

FIG. 12 is a computer display of a webpage for entering into the medication system the frequency that the patient is to take a medication;

FIG. 13 is a computer display of a webpage for entering the schedule of a patient's medication into the medication system;

FIG. 14 is a computer display of a webpage for entering notes regarding a patient's medication into the medication system;

FIG. 15 is a computer display of a webpage for confirming the medication information that was selected in FIGS. 8-14 for display on the patient's medication page (FIG. 6);

FIG. 16 is a computer display of a webpage showing various options available by selecting the field containing the name of the medication on the patient's medication webpage;

FIG. 17 is a computer display of a webpage for confirming medication information during the patient's request for a refill of a medication;

FIG. 18 is a computer display of a webpage for confirming the contact information of the healthcare provider that is to review the refill request and pharmacy where the refill is to be filled;

FIG. 19 is a computer display of a webpage for allowing a healthcare provider to review medication refill requests from multiple patients;

FIG. 20 is a computer display of a webpage for allowing a healthcare provider to deny a prescription request for a medication refill;

FIG. 21 is a computer display of a webpage for allowing a healthcare provider to prepare a prescription and to submit the prescription to a pharmacy;

FIG. 22 is a computer display of a webpage for allowing a pharmacist to review prescriptions submitted by healthcare providers through the medication system;

FIGS. 23-29 comprise a flow chart generally illustrating the medication system with respect to data management of a patient's medication;

FIG. 30 is a block diagram of a computer system comprising the medication system for data management of a patient's medications; and

FIG. 31 is a block diagram of the medication system for data management of a patient's medications.

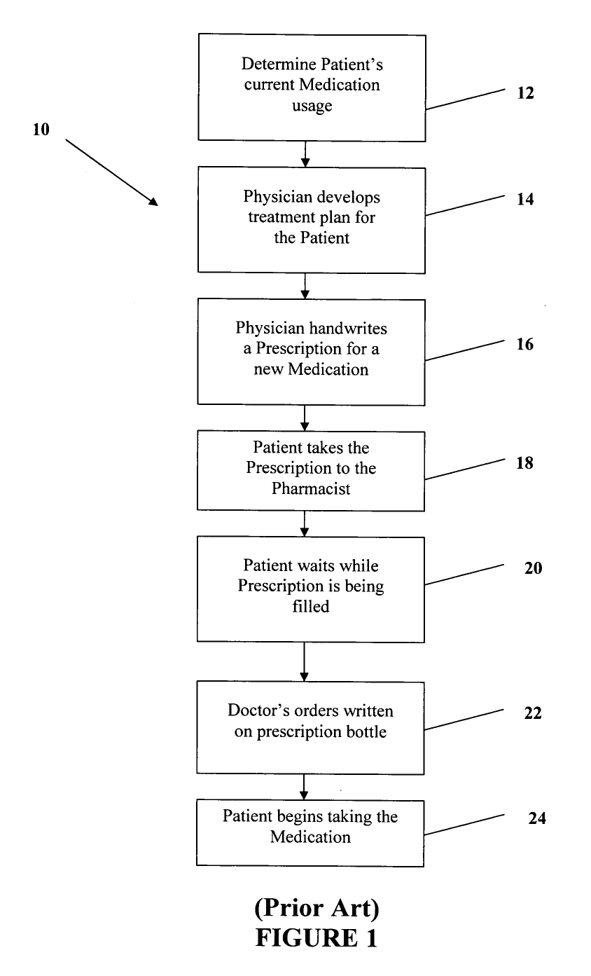

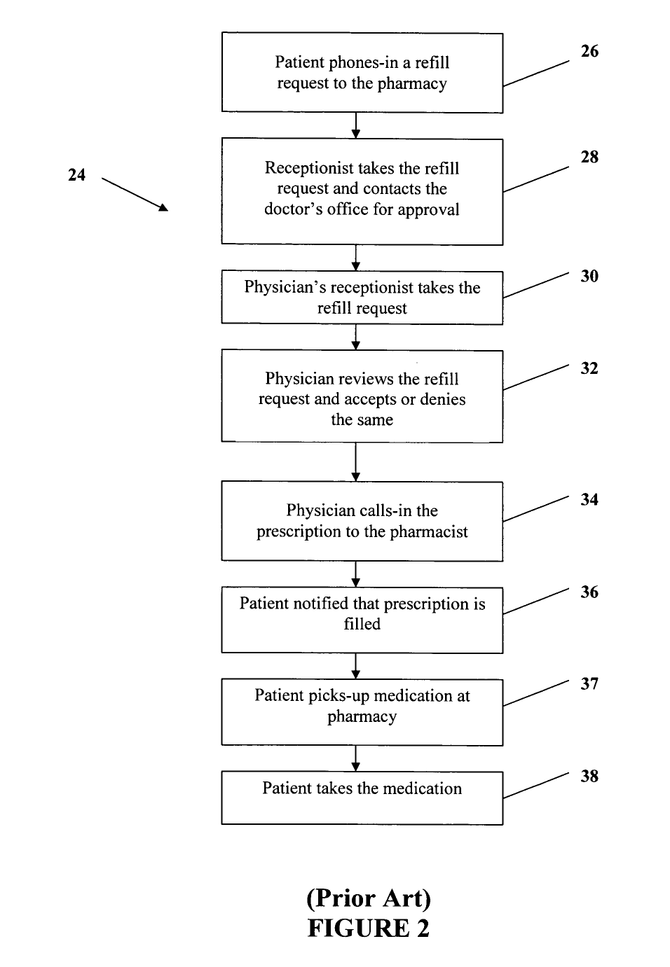

### DETAILED DESCRIPTION OF THE INVENTION

The present invention will now be described more fully hereinafter with reference to the accompanying drawings in which preferred embodiments of the invention are shown. This invention may, however, be embodied in many different forms and should not be construed as limited to the embodiments set forth herein. These exemplary embodiments are provided so that this disclosure will be both thorough and complete, and will fully convey the scope of the invention to those skilled in the art.

As used herein, the term “remote user”, “user” or “authorized user” includes a patient, healthcare provider and/or pharmacist, and their authorized agents. Additionally, the term “healthcare provider” includes physicians, doctors, nurse practitioners, psychiatrists and authorized agents thereof.

In an embodiment, a graphical user interface (GUI) is provided for allowing a user to interact with a computer in order to perform various tasks within the invented medication system, including selecting desired options, displaying stored medication data, allowing stored data to be modified and entering medication data for storage. The GUI further provides an interface through which users may communicate with each other. For example, a patient may submit a medication refill request to his healthcare provider. The user may interact with the GUI via a variety of ways, including by using a mouse or other input device to choose from a dashboard of options, presented in its windows on the screen, in the form of pictorial buttons (icons), soft buttons, lists, pull-down menus, dialog boxes, scroll bars, data fields, and other static and dynamic means as known in the art. Additionally, the medication system may be navigated by customary means in the art such as, for example, by hitting “enter” on a keyboard or clicking a pointer on “next” or “back”. Furthermore, it is to be understood that inputted, entered and selected data may be automatically stored in the system. Throughout this specification, it is to be understood that even though a particular means is described or illustrated for interacting with the GUI, other suitable means as known in the art may be used.

As used herein, it is to also be understood that terms such as web-page, page, screen, window, menu, field, data field, etc, are not to be construed as strictly limited to their specific definition. Instead, the terms are interchangeable where such interchangeability would be suitable in the art for the intended purpose.

In an embodiment of the electronic medication system, a system is described for data management of a patient's medications. Through the system, a healthcare provider, pharmacist and/or patient may review and update the patient's list of medications. By having computerized access to a patient's list of current medications, the time required by the healthcare provider in reviewing the patient's medical records, and other measures for obtaining a comprehensive medications list, is reduced. As such, more time may be dedicated to diagnoses and treatment of the patient.

In an embodiment of the medication system, a system is described wherein a patient, healthcare provider and/or a pharmacist may access additional information with respect to the patient's medications. For example, the physical form of the medication, the route by which it is to be taken, dosage, possible side-effects, allergic responses, and potential adverse drug interactions may be quickly reviewed through the use of a computer. This additional information may be used to assist the healthcare provider in diagnosing the patient. Moreover, the patient, having greater access to information concerning his medications, benefits by gaining a greater understanding of the treatment measures.

In an embodiment of the medication system, a system is described wherein a patient, healthcare provider and/or pharmacist may communicate with each other regarding a patient's medications. For example, a patient may message medical concerns to his healthcare provider, or, a healthcare provider may provide special instructions for the patient regarding usage of a particular medication.

In an embodiment of the medication system, a system is described for efficiently prescribing medication while reducing the number of errors as compared to conventional prescription writing. That is, a healthcare provider may use the system to prepare and submit prescriptions to a pharmacist. And, a patient may also use the system for requesting prescriptions for refills.

In an embodiment of the medication system, a medication module may attach meta-data to various data inputted or stored in the system in order to allow for the data to be searched. Preferably, searching the system is restricted to designated persons, such as a system administrator, who may query the system by using the meta-data. For example, the administrator may search for key-words such as a medication name, physician's area of practice, or other stored data.

Data stored by the medication system may be searched in order to match a particular advertisement to data that represents a particular type of user. For example, the system may identify users as being patients via their log-in information and search for terms that identify which of the patients have been prescribed a particular medication. Advertisements may then be associated with this identified group so that targeted ads may be displayed on various windows of the medication system once the patient logs-in. As another example, the system may be searched for users that are physicians in a particular practice area or who have prescribed a specific medication. Advertisements may then be associated with the identified physicians so that targeted ads are displayed in the various windows of the medication system once the physician logs-on. Accordingly, drug manufactures are able to advertise and present information regarding their drugs directly to relevant parties. For example, drug costs, drug comparisons, new drugs, generics and drug advisories may be targeted to specific groups of healthcare providers, pharmacists and/or patients through the medication system. As it will be appreciated by those skilled in the art, advertisements (generally shown by reference number 39 throughout the drawings) may be displayed on any and all windows within medication system.

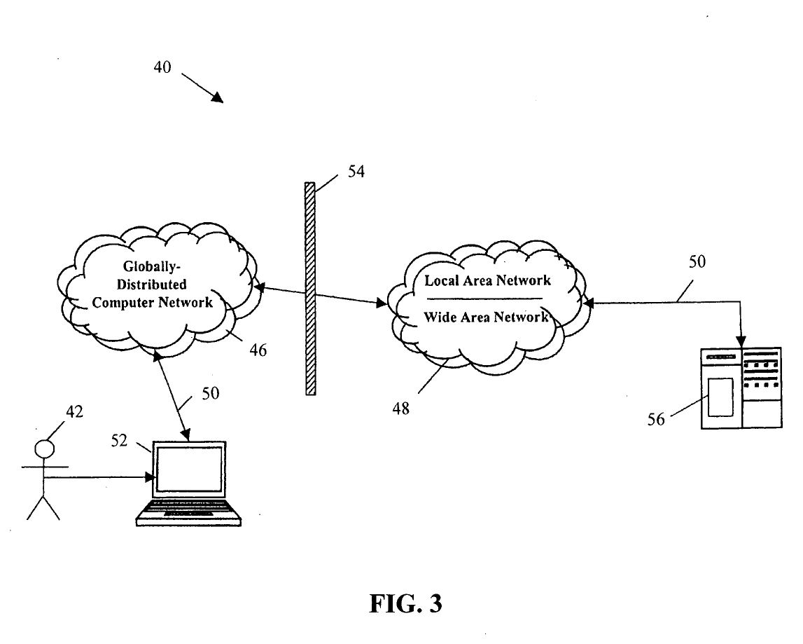

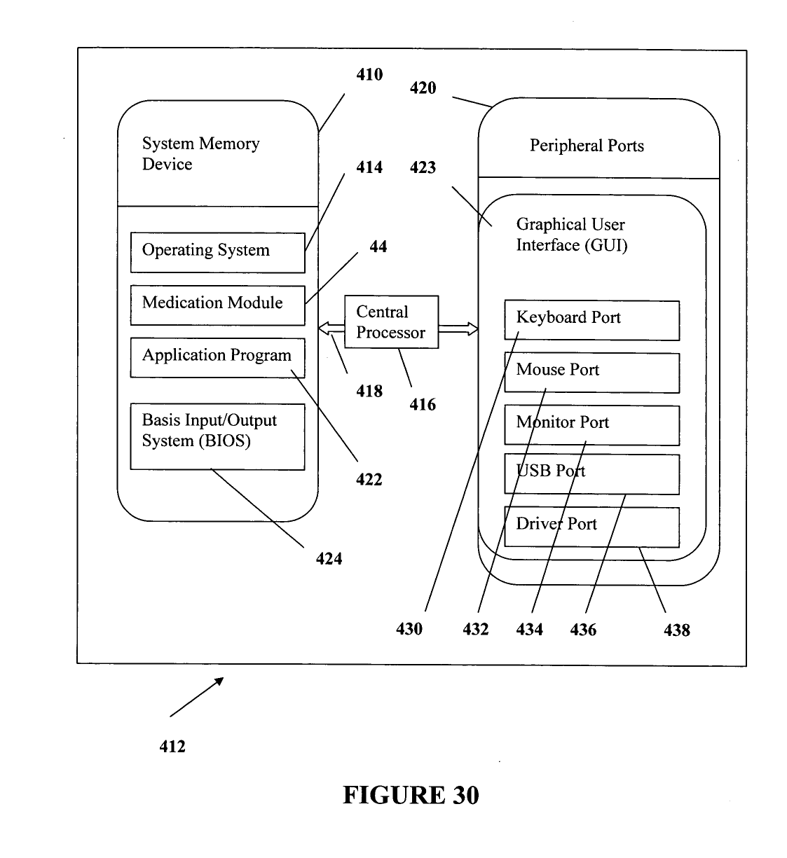

Referring to FIG. 3, in an embodiment, a computerized system 40 for managing data associated with a patient's medications allows for a remote user 42 to log onto a globally-accessible medication system and create, change, store, read and search for a multitude of patient data. The globally-accessible system 40 preferably includes at least one web page that contains or is in communication with a medication module 44 (FIG. 30). The web page is preferably secure and may include a plurality of dynamic menus, drop-down lists, links, windows, data fields, and the like, displayed on a graphical user interface.

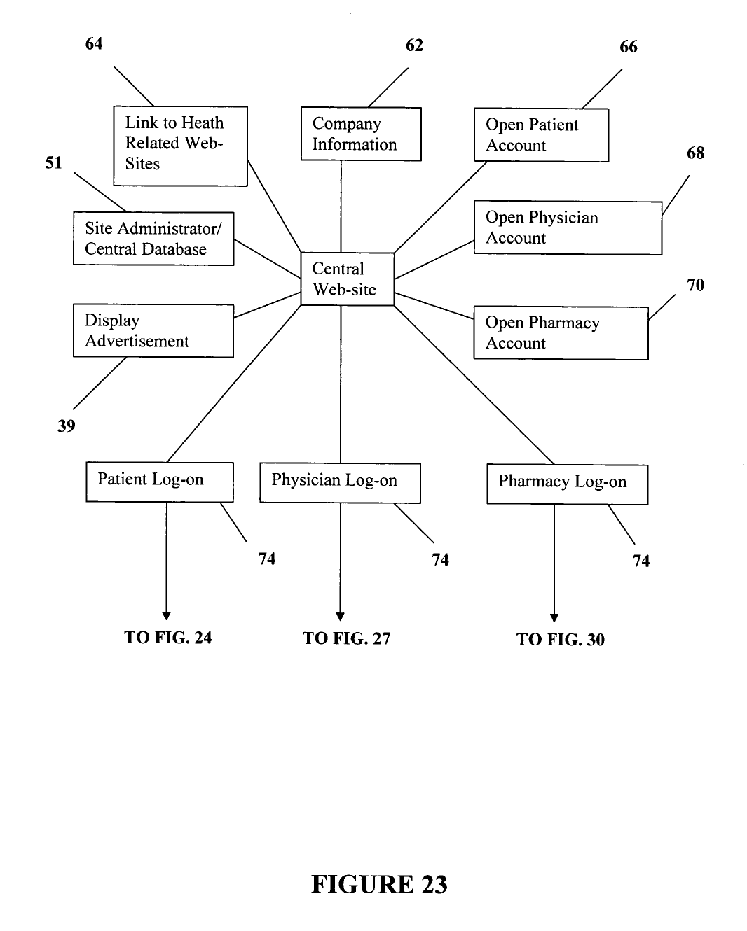

The remote user 42 is linked to the system's web page via a globally-distributed computer network 46, such as the Internet or an intranet, and/or a local area network/wide area network (LAN/WAN) 48. This link may be established along one or more data communication lines 50, or via wireless interfaces. The remote user 42 may view, submit and submit data, and the administrator 51 (FIG. 23) query the medication system at the web page through a browser application run by a computer 52, such as a desktop or laptop personal computer, personal digital assistant, palm device, BlackBerry™, tablet PC, or other wire or wireless devices. Through the web page, the remote user 42 is linked, through a firewall 54, to the medication module 44 (FIG. 30) which operates on the patient data. The web page may reside in a persistent storage device 56, such as an application server, a web server, a file server, or a database server, for example. The medication system is set-up such that the server 56 may communicate information to and acquire information from a plurality of remote users 42 simultaneously.

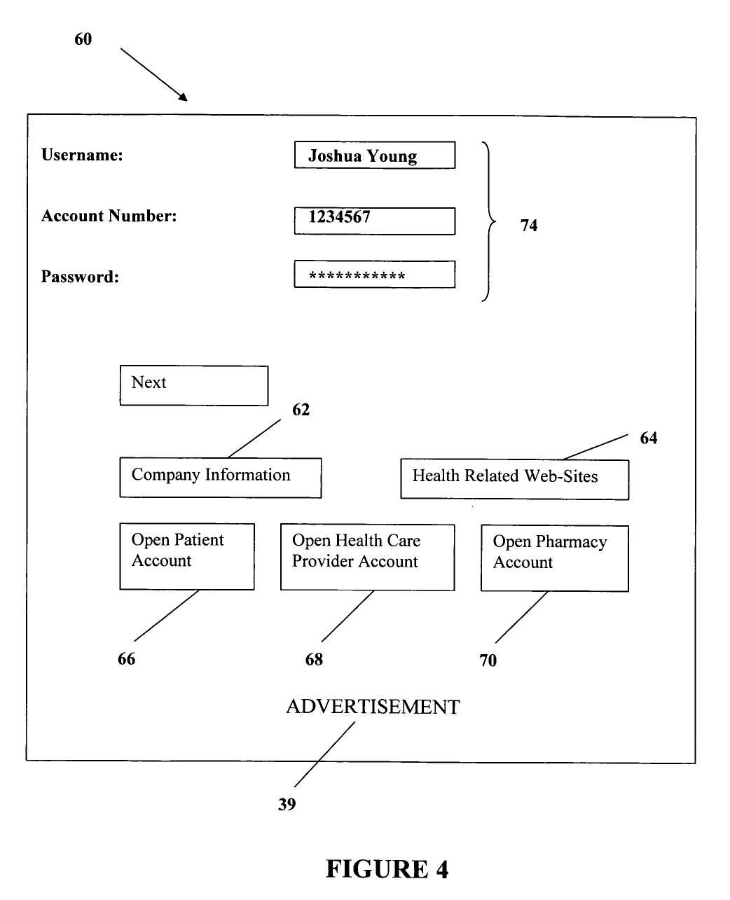

In an embodiment, the user uses a computer and the Internet to view a first login web page of the medication system, such as the web page 60 illustrated by FIG. 4. From the first login page 60, a user may select various options that are available to the public at large, that is, without having to log-on to the system. For example, the user may select the option company information 62 in order to open a window having company information such as customer support, contact information and frequently asked question. As another example, the user may choose to be linked to various health-related web-sites 64 in order to research a particular medication or ailment.

Also, from the first login page 60, a user may open an account to access the medication system by selecting the proper classification option of patient account 66, health care provider account 68 or pharmacist account 70. Upon making a selection, a window (not shown) is opened having data fields for entry of user specific information such as the user's name, address, e-mail address, facsimile number, telephone number, other contact information, professional degree and DEA number, if applicable. When a new account is being established, the classification of the user will be identified and stored. When the user is a healthcare provider or a pharmacist, his classification will be verified by the administrator by confirming the user's status with the appropriate State Licensing Board or by other valid means. Information with respect to the type of medicine being practiced by a healthcare provider and/or other types of information may also be collected in order to better target pharmaceutical advertisements 39.

The classification of the user may be used to determine which portions of the system may be accessed by a particular user. For example, only the healthcare provider has access to the portions of the system that allows for prescription to be generated and submitted to a pharmacy. It is noted that any of the various options within the medication system may be locked-out for a specific user or for a class of users.

Referring to FIG. 4, to log-on 74 to the medication system, the user enters his usemame, password and/or account number into respective data fields via an input device in order to access other portions of the medication system. The input device may include, for example, a keyboard, mouse, plotter, voice activated system, or medication card.

As used herein, the term “medication card” is defined as an article having a magnetic tape wherein the tape contains data readable by a device as to positive identification of the user, or an article having a bar code readable by a device, or an article having memory readable by a device such as a computer. Accordingly, it is contemplated that the medication card may come in different forms and the data contained therein be accessed by a myriad of different devices in a variety of ways.

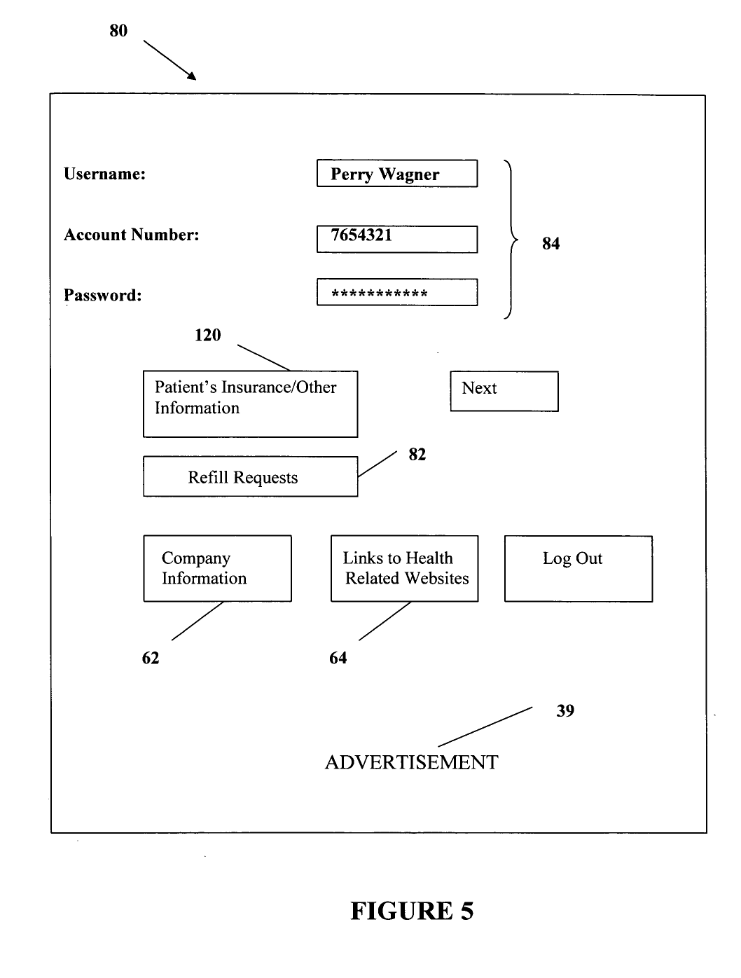

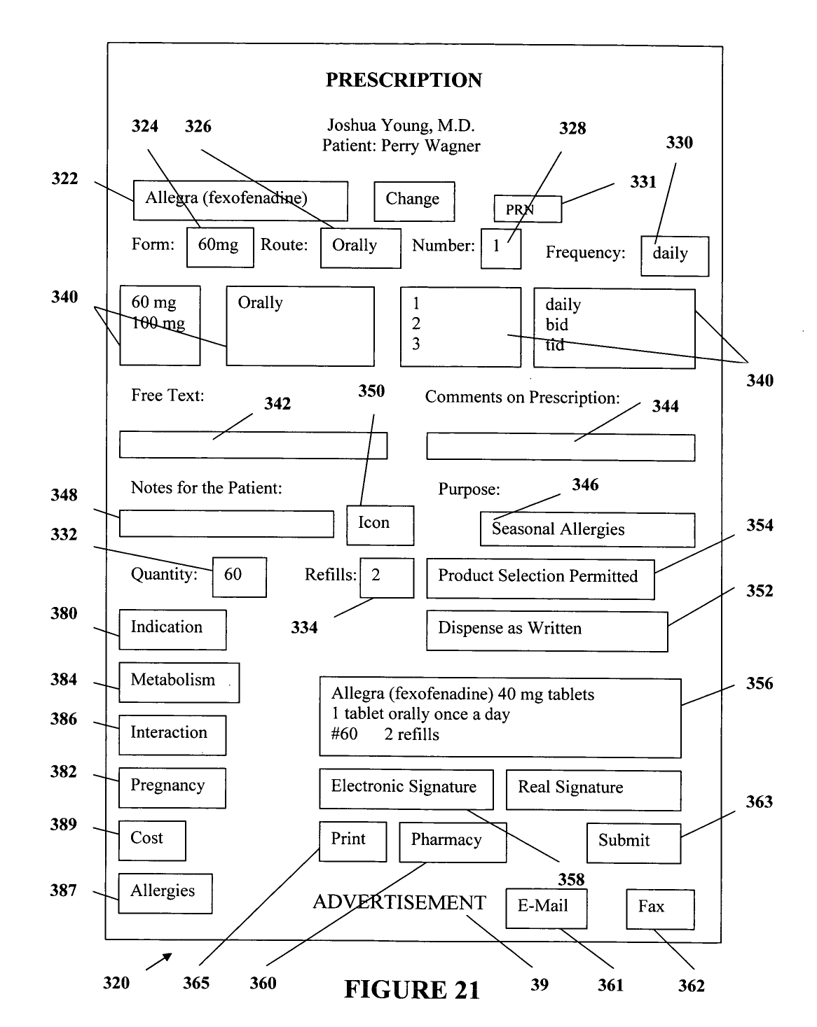

After the initial login, when the user's classification is either a healthcare provider or a pharmacist, a second login web page 80 may be provided, as illustrated by FIG. 5. The second login page 80 allows for tasks to be performed that are unavailable to the patient. For example, only a healthcare provider has the option to review refill medication requests 82 or to prepare prescriptions (FIG. 21).

The healthcare provider and/or pharmacist may also access a particular patient's medication data by entering the patient's log-in information 84, i.e. username, account number and password, into the second login page 80, which may be accomplished by using an input device, such as by scanning a patient's medication card. The system, recognizing that a healthcare provider is accessing a patient's data, allows access to additional options that are unavailable to the patient. For example, only the healthcare provider may prescribed new medications (FIG. 21) by means of the system, as further described below.

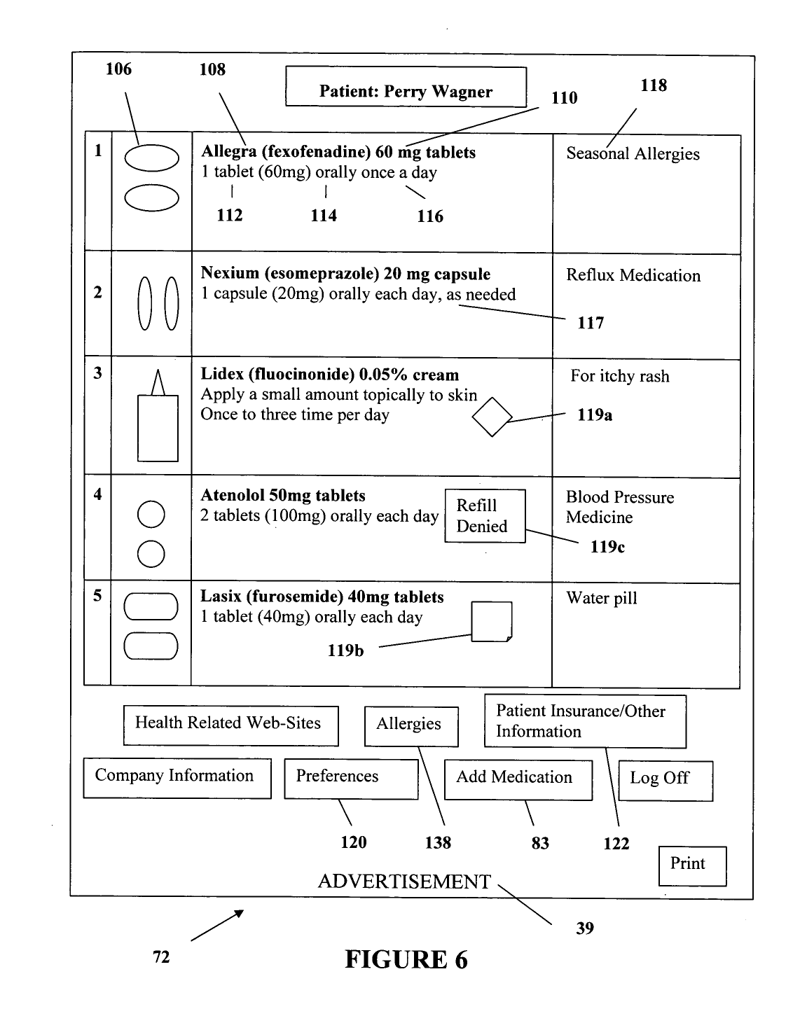

FIG. 6 illustrates a preferred embodiment of a medication web page 72 that is displayed after patient login information is entered, either through the first or second login page 60, 80. The medication web page 72 may include an option for adding medication 83 to the page and fields for displaying a picture of the patient's medication 106, the name of the medication 108, its form 110, dosage 112, route 114, frequency 116, schedule 117, purpose 118 and any note 119a, 119b, 119c regarding the medication. The medication page 72 may also include options to access the patient's healthcare provider and pharmacy preferences 120 and particulars regarding the patient such as a patient's insurance information 122. The medication page 72 is considered the “home page” and may be returned to by selecting the option home 124, as shown in various Figures.

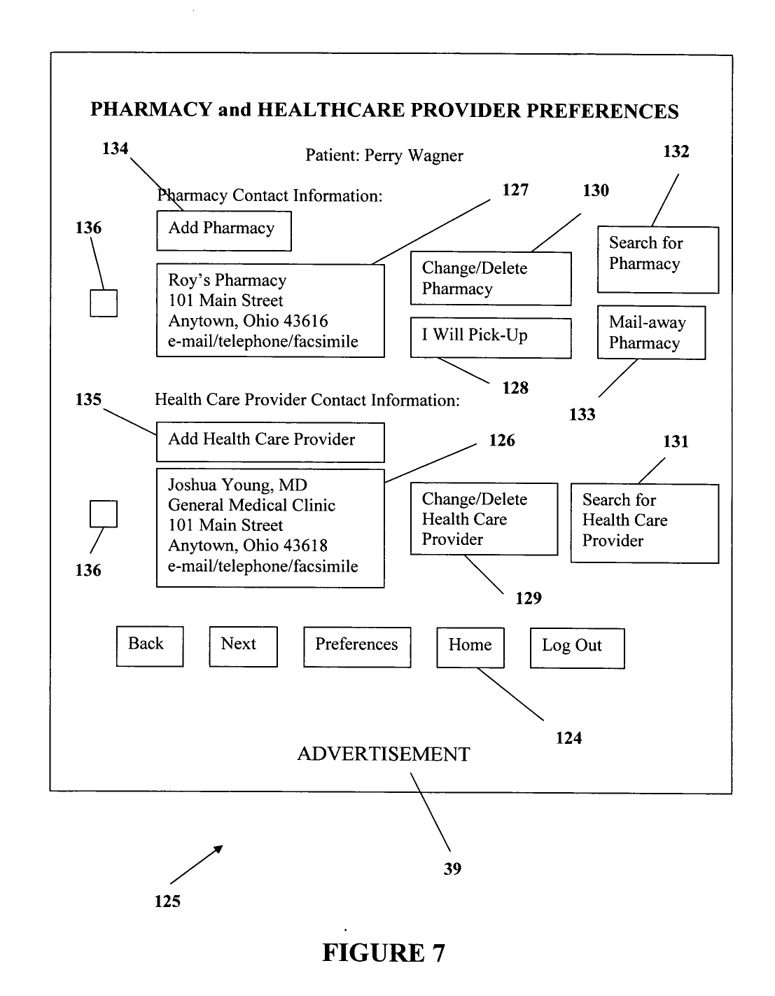

By selecting the option preferences 120, a window 125 is displayed having data fields for entering and displaying the patient's healthcare provider contact information 126 and the pharmacy contact information 127, as illustrated in FIG. 7. Inputted information is stored as a default setting, identifying the healthcare provider who is to receive and review the patient's refill request and to which pharmacy the healthcare provider is to submit the prescription. The user may also enter when he will pick-up the medication at the pharmacy by selecting the option pick-up 128, then entering the date and time into data fields of a window (not shown).

The user may replace the default healthcare provider and pharmacy information by entering the new contact information into the respective data fields 126, 127 or by selecting the option change 129, 130. When the option change 129, 130 is selected, a list of previously entered and stored healthcare providers or pharmacies is displayed from which the user may select.

The user may also search for a healthcare provider or a pharmacy by selecting the respective option search 131, 132. By selecting search 131, 132, the user is linked to a database having a list of healthcare providers or pharmacies nearest to a zip code entered by the user. The user may also search for and select mail-away pharmacies by selecting the option mail-away pharmacy 133. In each case, the newly selected pharmacy or healthcare provider is saved as the respective default setting.

It is contemplated that several pharmacies and healthcare providers may be simultaneously listed in the preferences window 125 by respectively selecting the option add pharmacy 134 and add healthcare provider 135. The user may then select which of the healthcare providers that the prescription request is to be sent and which of the pharmacies that the prescription is to be sent to checking the corresponding box 136.

Referring to FIG. 6, the medication system also allows for the patient's insurance information to be entered, modified, stored and displayed. By selecting the option patient's insurance 122, a window is displayed (not shown) having data fields for entering the patient's insurance plan, carrier contact information, and other related information. As such, the healthcare provider and pharmacy readily have all of the patient's insurance information available, which is particularly useful when the patient does not bring his insurance card.

The user may also enter, modify, store and have displayed the patient's allergies by selecting the option allergies 138. A window is displayed (not shown) having data fields into which the user may enter the different substances to which the patient is allergic, the character of the allergic reaction, and/or other related information. Accordingly, the user has a consolidated listed of the patient's allergic responses in order to aid in diagnosis and treatment of the patient.

It is contemplated that other options and data fields may be provided with respect to patient information. For example, a patient may be able to select an option that displays a general health form, including past medical history, family history, and other customary information, for the patient to fill out prior to an office visit. Either the patient or healthcare provider may print the filled-in form, thereby realizing time savings during an appointment. As another example, an option to fill out a request for a release of medical records form may be provided to the user. In current practices, a release form is required where a patient has had treatment or test performed by another physician whereby the form allows that physician to release the previous information to a new physician. As it will be appreciated by those skilled in the medical arts, even though the release form may be filled out and made available through the medication system, the actual medical records would likely still be sent in the mail, however, the process overall would be sped up and simplified.

Referring to FIG. 6, the user may add a medication to the medication page 72 by selecting the option add medication 83. When the add medication option 83 is selected, different options are provided depending on whether the user logged-on as a healthcare provider or as other than a healthcare provider, such as for example as a patient. The description immediately following is based on the user being logged in as other than a healthcare provider, whereupon a series of windows will be provided for inputting the name of a desired medication 108, its picture 106, form 110, dosage 112, route 114, frequency 116, schedule 117, purpose 118 and notes 119a-119c regarding the medication. The inputted data is saved by the system and displayed on the patient's medication page 72.

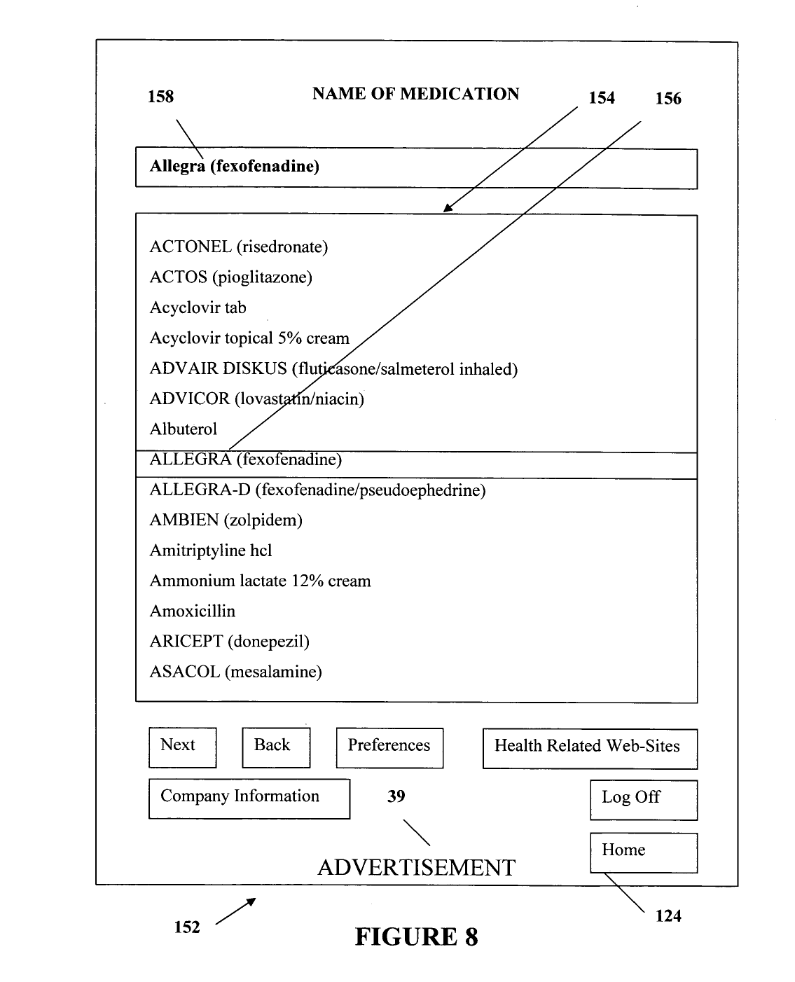

The first window, illustrated by the name of medication window 152 of FIG. 8, displays, from a database, a searchable, alphabetized listing 154 of medications. To locate the desired medication 156, the user may scroll up and down the list or type in the medication name into the provided data field 158 which will cause medications having a similar spelling to be displayed. Once the desired medication has been typed-in or highlighted, the user may select the medication by double clicking on the medication 156 or by hitting enter, for example.

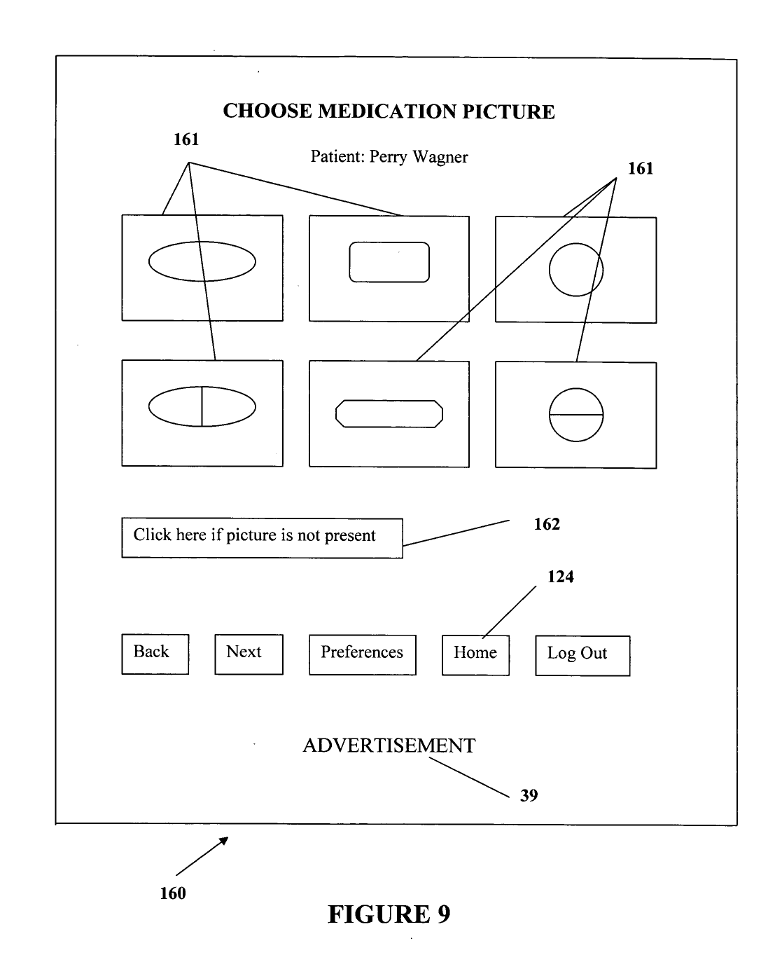

After completing the name of medication window 152, a database is accessed that displays, in a medication picture window 160, alternative pictures 161 of the medication from different vendors, as illustrated by FIG. 9. The user may select the desired picture by selecting the appropriate field 161. The user may also select no picture 162 where the proper picture is not present.

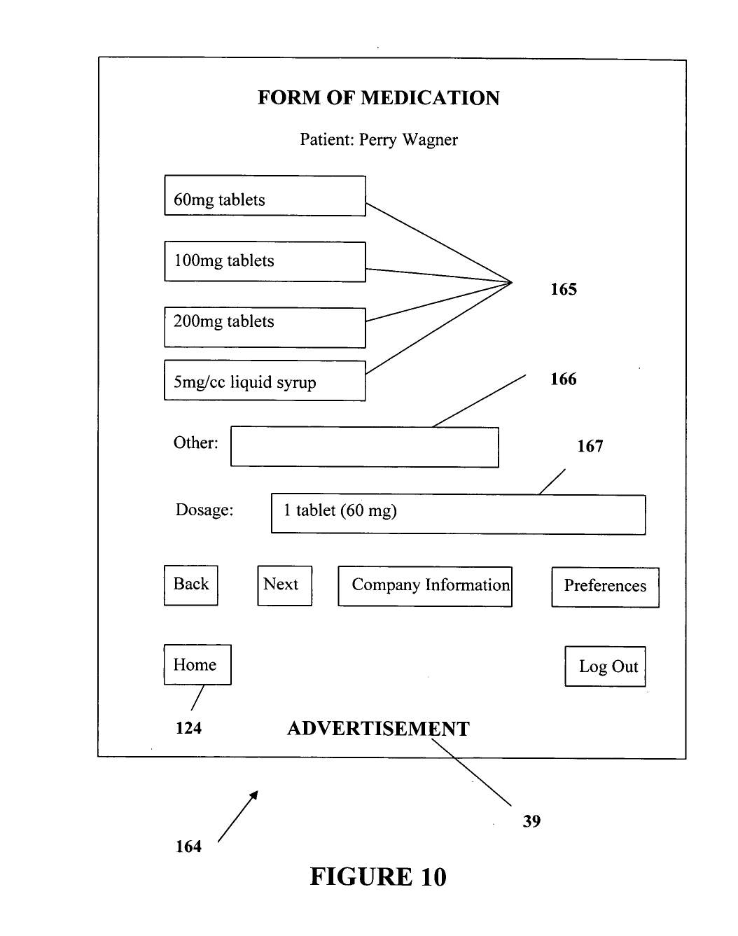

Thereafter, a form of medication window 164 may be provided, as illustrated by FIG. 10. This window 164 allows for the form of the medication, such as whether the medication is in tablet or liquid form, to be entered and/or changed. Selectable settings 165 may be automatically provided from a database for the most common forms of the medication as identified in correlation to the previously chosen medication name. Additionally, a data field 166 may be provided into which the user may enter the form.

A data field 167 may also be provided for entering the dosage of medication. By default, a data base will provide in the data field 167 the most common dosage, based on the previously selected medication name and form. Notwithstanding, the user may change the shown dosage by entering the desired data.

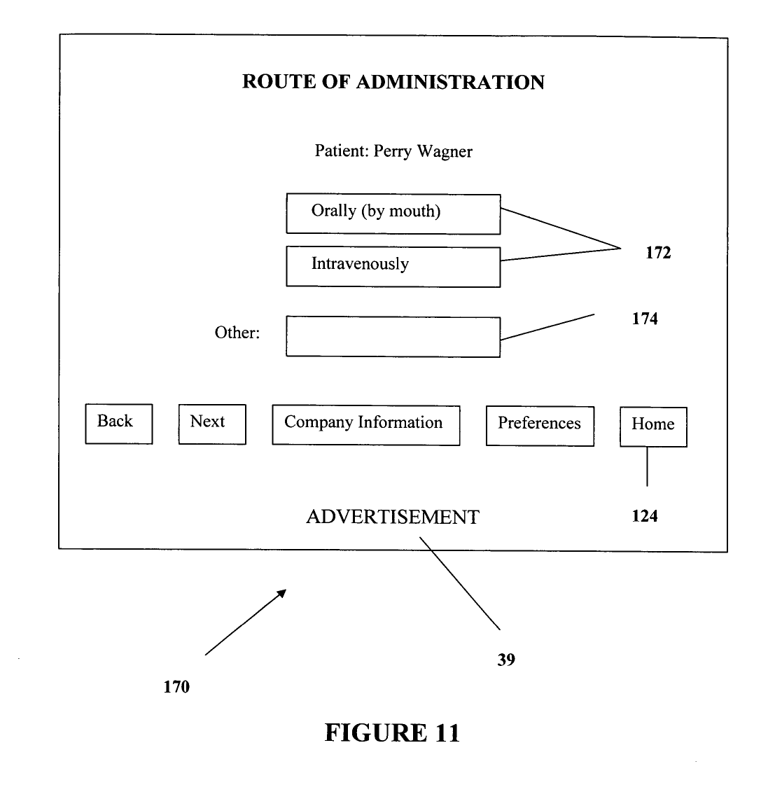

Upon completing the medication form window 164, a medication route window 170 opens, allowing for the user to enter the route of administration, such as whether the medication is to be taken orally, intravenously, via inhalation, or other suitable route, as illustrated in FIG. 11. Selectable settings 172 may be automatically provided from a database for the most common routes for the selected medication name. Additionally, a data field 174 may be provided into which the user can enter the route of administration.

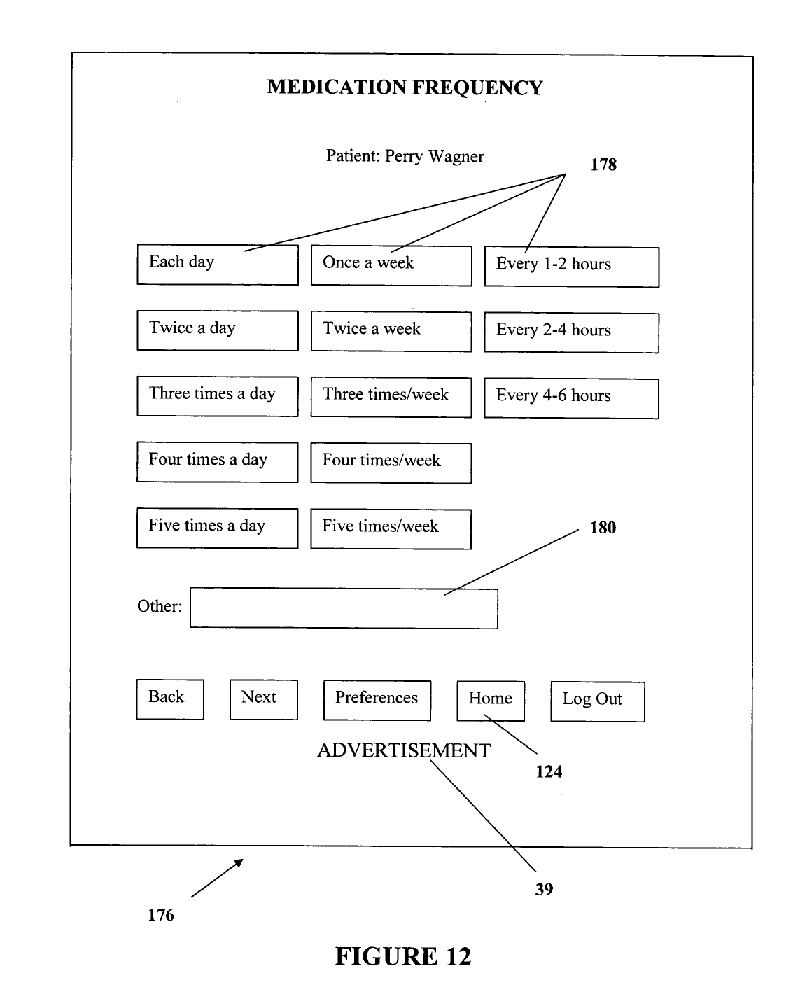

Referring to FIG. 12, a medication frequency window 176 is then provided for allowing the user to enter the frequency at which the medication is to be taken. Selectable settings 178 may be automatically provided from a database for the most common frequencies with respect to the selected medication name. Furthermore, a data field 180 may be provided into which the user can enter the frequency that the medication should be taken.

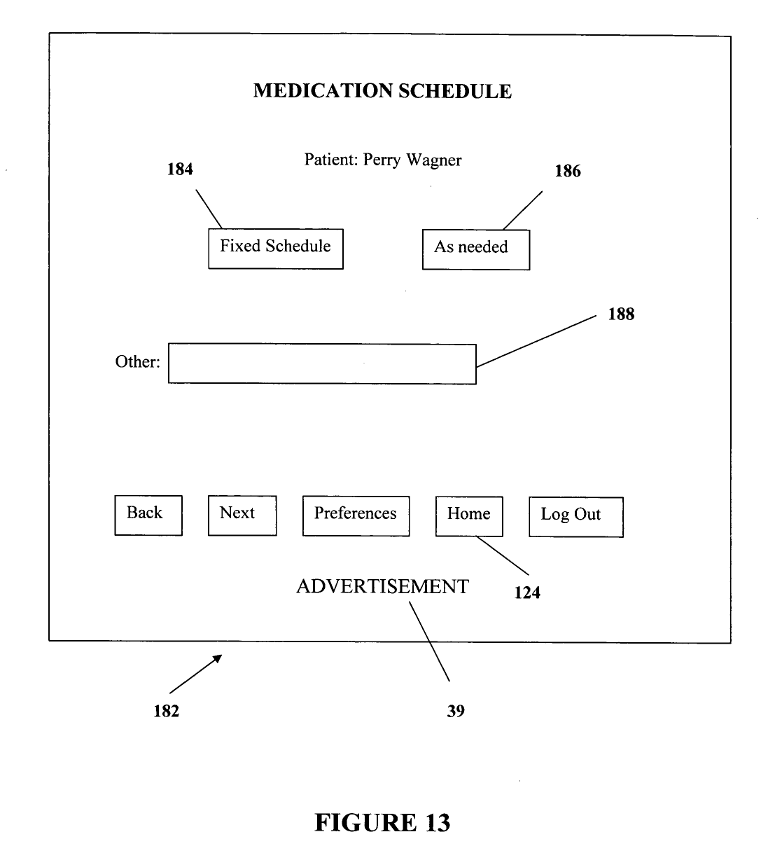

Thereafter, a medication schedule window opens 182 wherein the user may select whether the medication is to be taken on a fixed schedule or as needed by selecting the respective desired option 184, 186, as illustrated in FIG. 13. A data field 188 is also provided for entry of an alternative schedule.

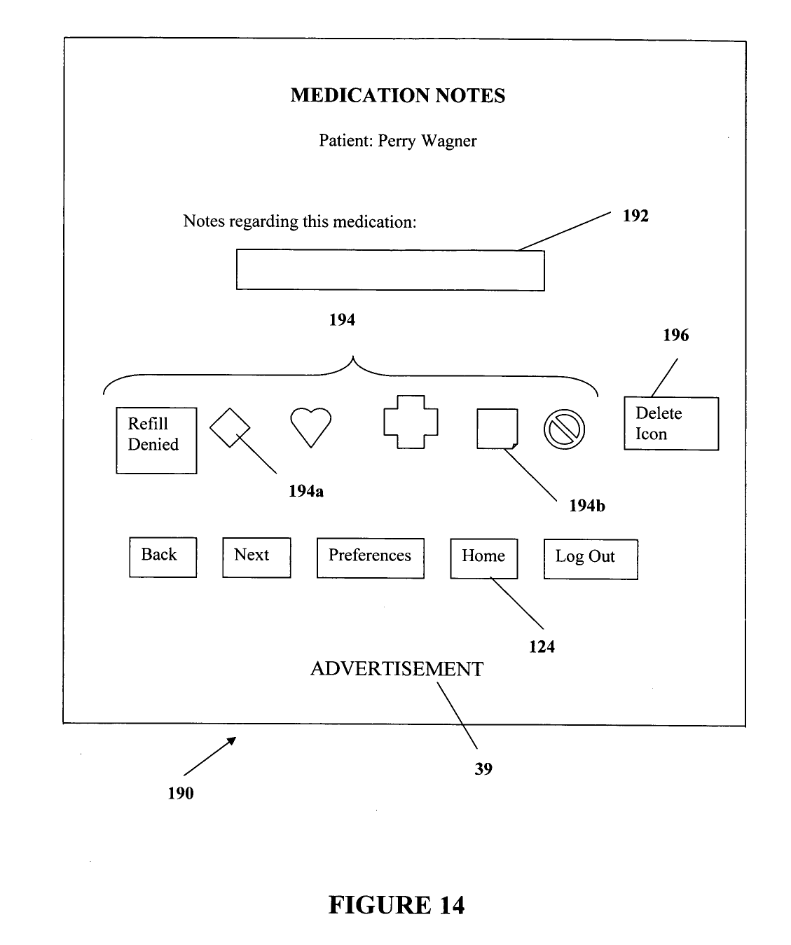

Referring to FIG. 14, a medication notes window 190, having a data field 192 and icons 194, then opens to allow a user to enter a note with respect to the medication. For example, a healthcare provider may enter instructions cautioning the patient as to the use of the medication, reminding the patient that the present medication replaces a previously prescribed medication or that the patient's refill request has been denied. As another example, the patient may enter a note regarding a concern or question that the patient desires to review with the healthcare provider during the next appointment.

After inputting the desired note into the data field 192, the user then selects a corresponding icon 194. Different icons 194 may be provided for various categories of notes. For example, a yellow yield diamond symbol 194a identifies that there is a note cautioning the patient regarding the usage of the medication while a notepaper symbol 194b identifies that the patient has a question or concern for the healthcare provider regarding the medication.

Thereafter, a medication purpose window (not shown) opens for allowing the user to enter the purpose of the medication into a data field. The intention of having this window is to allow for the medication purpose to be expressed in layman's terms in order to aid the patient in understanding and remembering what the medication is to be used for.

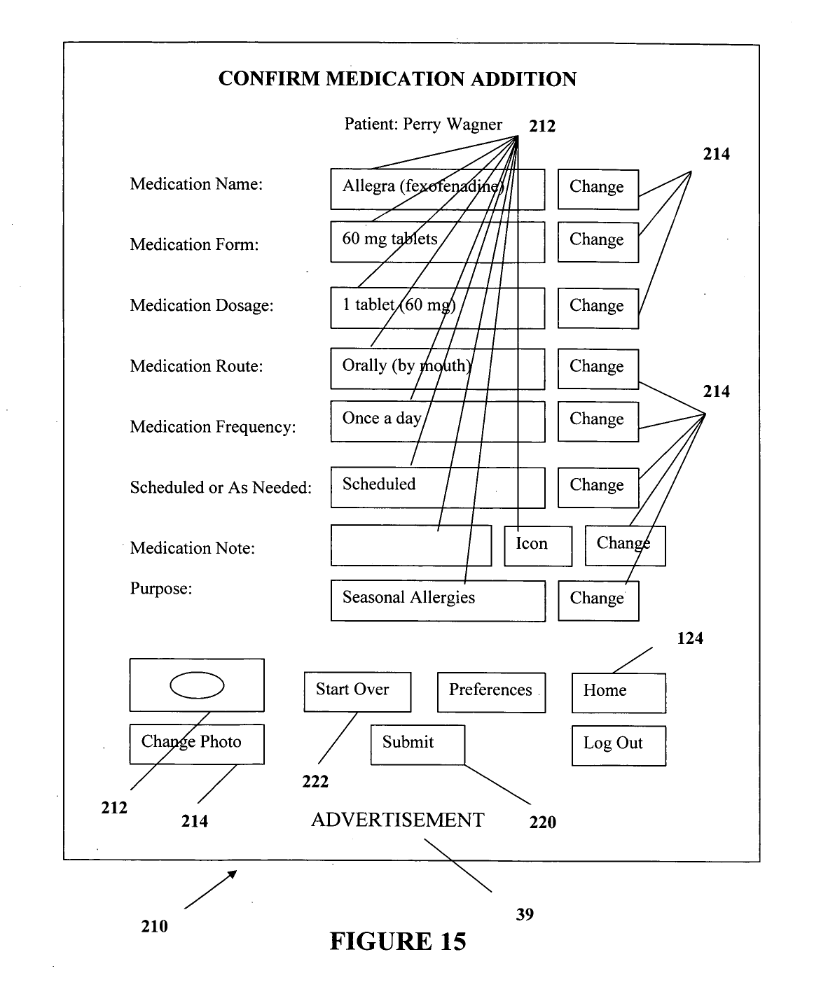

Referring to FIG. 15, a medication addition confirmation window 210 is provided for listing inputted data 212 from the previous windows 152, 160, 164, 170, 176, 182, 190. When the user desires to change or modify the data 212, the user may return to any of the previous input windows by selecting the corresponding option change 214 wherein the user may replace data in the same manner as the data was originally entered.

Once the user is satisfied with the inputted data 212, he may save the data for display in the medication page 72 (FIG. 6) by selecting submit 220. The system will automatically store the particulars of the user who made the addition, as identified by the user's log-on, so that the user will have an entry of the person who added the medication. The user may also select the option start over 222 in order to be re-prompted through the series of windows, as described above.

Referring to FIG. 6, once a medication has been inputted into the system, the saved data may be changed, replaced, modified or deleted so that newly entered data will now be displayed in the medication page 72. By selecting various fields provided on the medication page 72, the user is returned to the previously described input windows 152, 160, 164, 170, 176, 182, 190 wherein the new data may be entered in the manner as previously described. From any of these windows, the user may directly return to the medication page 72 by selecting home 124.

In brief, by selecting the field containing the picture of the medication 106, the user is returned to the medication picture window 160 (FIG. 9) wherein a new picture may be selected, replacing the previous selection. Likewise, by selecting the purpose of the medication field 118, the user is returned to the medication purpose window (not shown) wherein the data therein may be replaced by newly entered data. In the same fashion, by selecting the data field containing an icon (119a, 119b or 119c, for example), the user is returned to the medication notes window 190 (FIG. 14) wherein the user may read, change or delete the note and associated icon. Similarly, the user may select the fields containing the form 110, dosage 112, route 114, frequency 116 and schedule 117 of the medication in order to return to windows 164, 170, 176, 182 (FIGS. 10-13) and change or delete the previously inputted data.

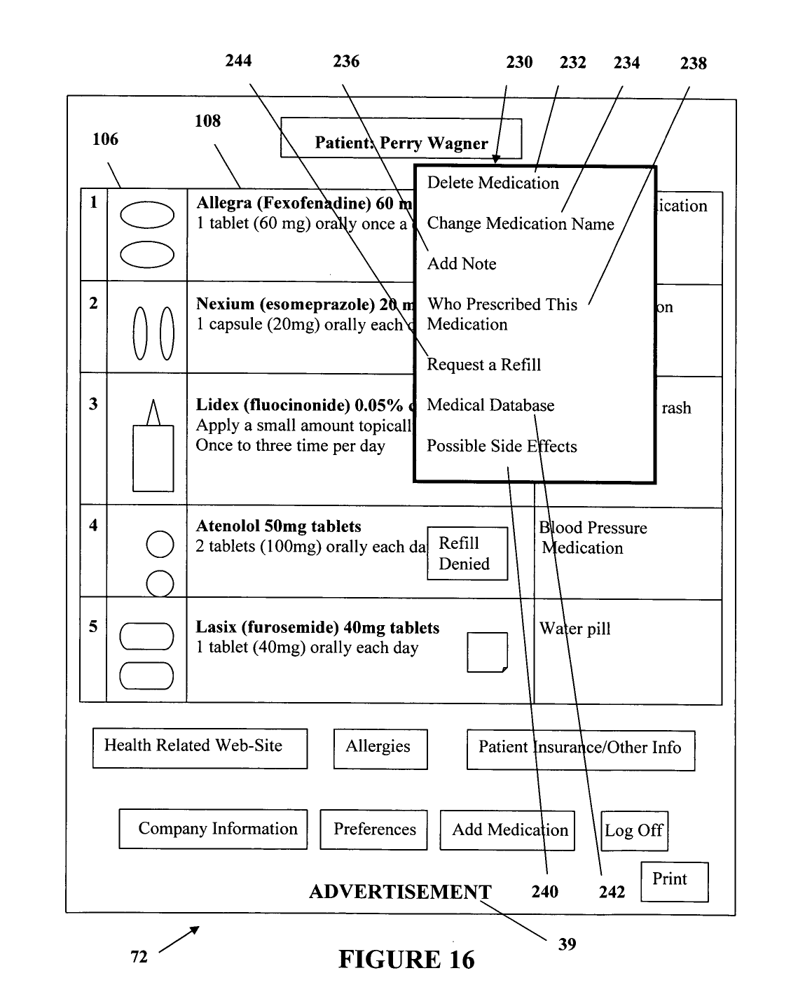

By selecting the field containing the name of the medication 108, a menu 230 is displayed that allows for the user to select from a plurality of options relating to the patient's medication, as illustrated by FIG. 16. Various options include being able to delete the listed medication 232, change the medication name 234, add a note 236 for review by the healthcare provider during the next appointment, identify who prescribed the medication 238, access a database listing possible side effects of the medication 240, access a medical database 242 to read additional information with respect to the medication and request a prescription refill 244.

The user may delete a particular medication from his medication window 72 by selecting the option delete medication 232. Optionally, a confirmation window (not shown) may appear, displaying the selected medication in order to ensure that the user desires the deletion. The system may archive the deleted medication by date discontinued or started in order to allow the user to review previous medications.

To change the name of a medication, the user selects the option change medication name 234. The name of medication window 152 is provided, displaying from a database, a searchable, alphabetize listing 154 of medications, as illustrated by FIG. 8. The user may select a new name for display on the medication page 72 (FIG. 6) by selecting the name in the manner as previously described.

Referring to FIG. 16, the user may enter or determine who prescribed the medication by selecting the option who prescribed this medication 238. Thereafter, a window (not shown) will open having data fields for entering, changing and/or displaying identifying information such as, for example, the prescriber's name, degree, organization, address and phone number. Preferably, this information is automatically displayed based on the healthcare provider's stored information, when the healthcare provider adds a medication to the medication page or grants a prescription refill. When a patient adds a medication, for example an over-the-counter medication or a medication from a healthcare provider who is not using the system, then the system will identify the patient via his log-on and display his name as being the person who prescribed the medication.

The user may access a database that will have medical facts with respect to a particular medication by selection the option medical database 242. The database matches data with the corresponding medication name in order to target relevant medical information.

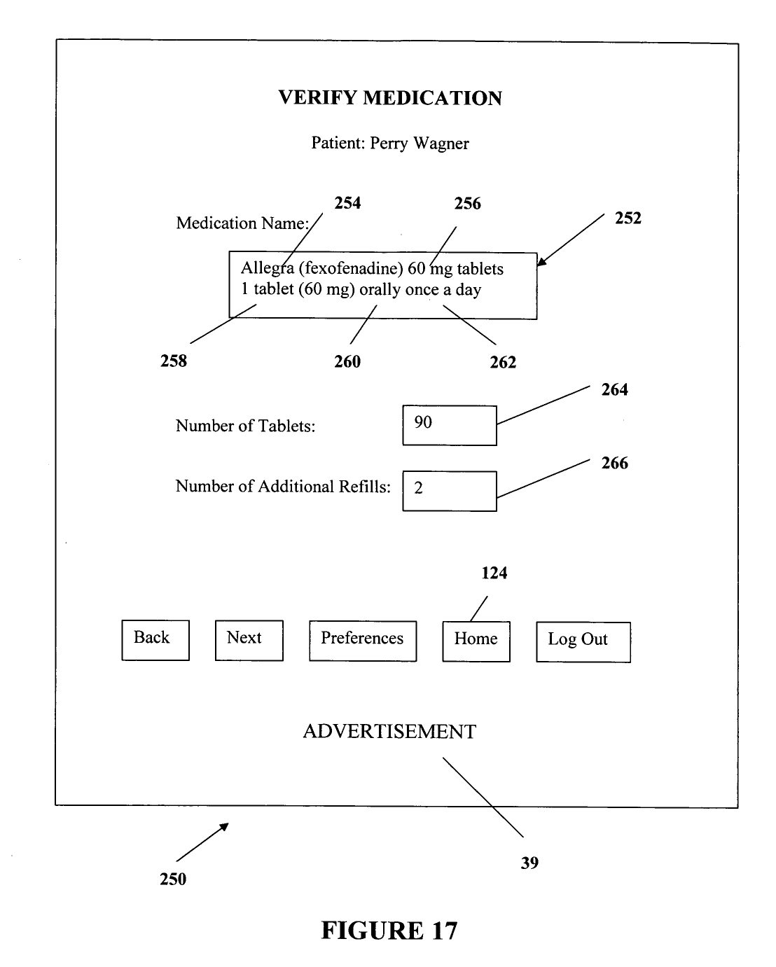

Referring to FIG. 16, the medication system also allows for the user to request a prescription for a medication refill. By selecting the option request a refill 244, a verify medication window 250 is provided that displays in a data field 252 the selected medication 254 and its associated information such as its form 256, dosage 258, route 260, frequency 262 and schedule, as illustrated in FIG. 17. Data fields 264, 266 are also provided for displaying the number of tablets and the number of additional refills, respectively. The data presented in these fields is automatically defaulted in from data that was previously entered and stored in the medication system. Preferably, the default data is derived from the data entered by the healthcare provider while he was originally prescribing the medication or granting a refill, whichever is most current. Alternatively, the displayed default data may be provided from the data that was stored for being displayed in the patient's medication page 72 (see FIG. 6). The user may change the default data by inputting desired information into the appropriate fields.

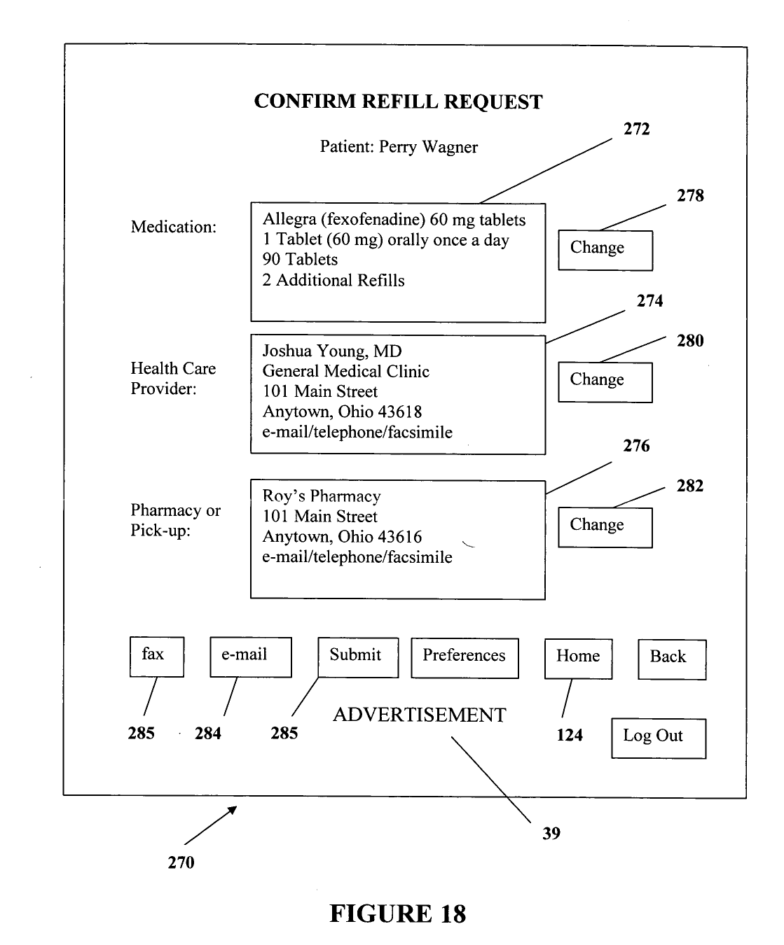

In order to confirm where the refill request is to be sent and filled, a confirm refill request window 270 opens having fields for displaying the medication information 272, healthcare provider contact information 274 and pharmacy contact information 276, as illustrated by FIG. 18. These fields 272, 274, 276 are filled by default with data that was previously entered into the system, such as by the information entered through patient's preferences 120 (see FIG. 6) and/or by the information entered when the healthcare provider or pharmacists established an account. Notwithstanding, the user may enter or modify the data by making the desired entry in the appropriate date fields 272, 274, 276 or by selecting the respective option change 278, 280, 282. When change 278, 280, 282 is selected, a respective list of previously entered and stored medications, healthcare providers and pharmacies are displayed from which the user may select. Moreover, different features (not shown) may be provided for aiding the user in locating a different healthcare provider or pharmacy. For example, the user may be able to search a database of healthcare providers and/or pharmacies based on the distance from the patient's zip code.

Upon completing the proper information, the patient may e-mail, fax or submit the refill request, by making the corresponding selection 283, 284, 285, in order to electronically notify the healthcare provider of the request and to save the refill request within the system.

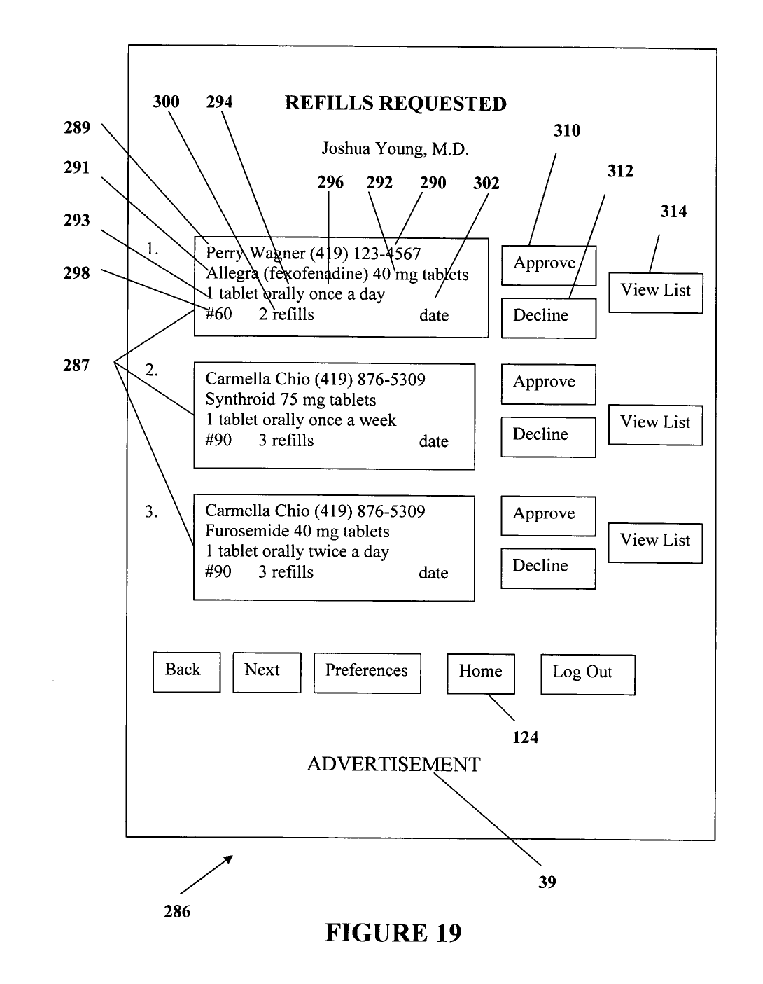

The option submit 285 advantageously allows for the healthcare provider to quickly and simply review, grant and deny prescription refill requests that were made through the system. That is, the system, recognizing the log-in (FIG. 4) as being that of a healthcare provider, provides the option refill requests 82 (FIG. 5). Upon making this selection, a refills requested window 286 opens having fields 287 for displaying pertinent information with respect to each refill request, as illustrated by FIG. 19. The refill information may include the patient's name 289, phone number 290, medication name 291, form 292, dosage 293, route 294, frequency 296, schedule quantity 298 number of additional refills 300 and date requested 302.

The refill request information is automatically presented based on the data entered and stored by the user, such as the data entered in the confirm refill request window 270 (FIG. 18). Alternatively, the system may identify the desired medication by its name and then populate the fields 287 with data based on the original prescription or last refill prescription, as entered by the healthcare provider (see FIG. 21).

The healthcare provider has the option to approve or decline the refill request by making the appropriate selection 310, 312. And, as needed, the healthcare provider may select the option view list 314 to view the patient's medication window 72 (FIG. 6) and, accordingly, the patient's entire medication list.

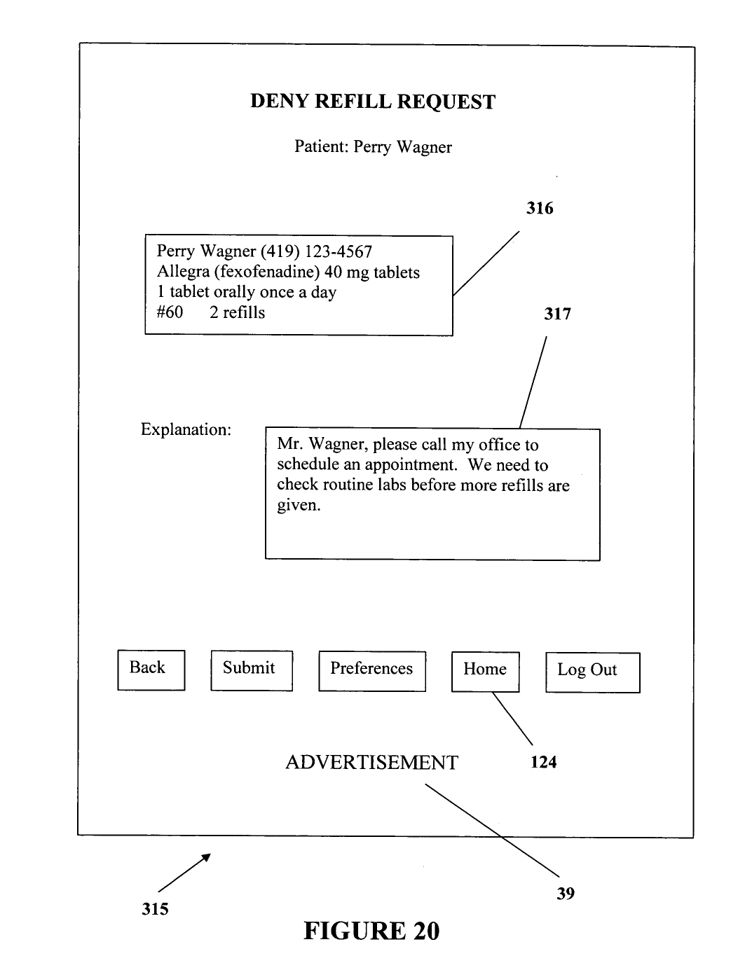

The healthcare provider may decline a refill request by selecting the option decline 312. Upon selecting decline 312, a window 315 is provided having a field 316 for automatically displaying the patient's refill request information, as illustrated by FIG. 20. Another data field 317 may also be provided for allowing the healthcare provider to input the reason for the denial.

The denial may be communicated to the patient in a variety of ways. For example, an icon such as “refill denied” icon 119c, or other indicator, may be caused to be displayed in the patient's medication window 72, as shown in FIG. 6. By selecting the denial icon 119c, the user may view a window (not shown) containing the healthcare provider's explanation for the denial. As another example, the prescription system may automatically e-mail the denial to the patient. As a further example, the system may be configured to call the patient with a pre-recorded message.

When the healthcare provider selects the option approve 310 (FIG. 19), a prescription window 320 is provided having data fields, as illustrated by FIG. 21. The data fields may be automatically pre-filled by data that was previously saved into the system as a time savings measure. For example, data entered by the patient in making the refill request may be presented in the fields by default. As another example, data entered by the healthcare provider during the original prescription grant or during the latest prescription for refill, may be automatically presented in the fields by default.

Preferably, data fields may be included for the medication name 322, form 324, route 326, number 328, frequency 330, schedule 331, quantity 332, and number of refills 334. The healthcare provider may change the default data by entering new information into the data fields by selecting from pre-determined choices 340 that are common to the particular medication or by inputting the desired information into the data fields. The above fields may be by-passed by inputting in the desired information into a free-text field 342. The free-text field 342 is particularly useful when an unusual prescription is being written that doesn't match well to the pre-determined choices.

Additional data fields 346, 348 may be provided for respectively inputting the purpose of the medication in layman's terms and for entering special notes for the patient 348. Where there are special notes, a yield sign 119a will be associated with the note unless the healthcare provider selects a different icon by selecting the option icon 350, which provides a list of selectable icons within a window (not shown).

Preferably, the above discussed data is automatically displayed in, and updates, the patient's medication page 72 (FIG. 6), in the same format as the other medications displayed therein.

A data field 344 may also be provided for inputting comments regarding the prescription. It is intended that the data entered therein will be included as comments on the pill bottle label.

As shown in FIG. 21, the healthcare provider may also select options to instruct the pharmacist to dispense the medication as written 352 or to permit product selection 354 such as a generic alternative.

Once the healthcare provider has completed inputting the desired information, the data is used to generate a prescription. First, the system automatically formats the relevant portions of the inputted data into a field 356, as it will be presented on the prescription, for the healthcare provider's final review. The healthcare provider may then choose to which pharmacy the prescription will be sent by selecting the option pharmacy 360. This option 360 causes the preferences window 125 (FIG. 7) to open wherein the healthcare provider may select the preferred pharmacy or another pharmacy.

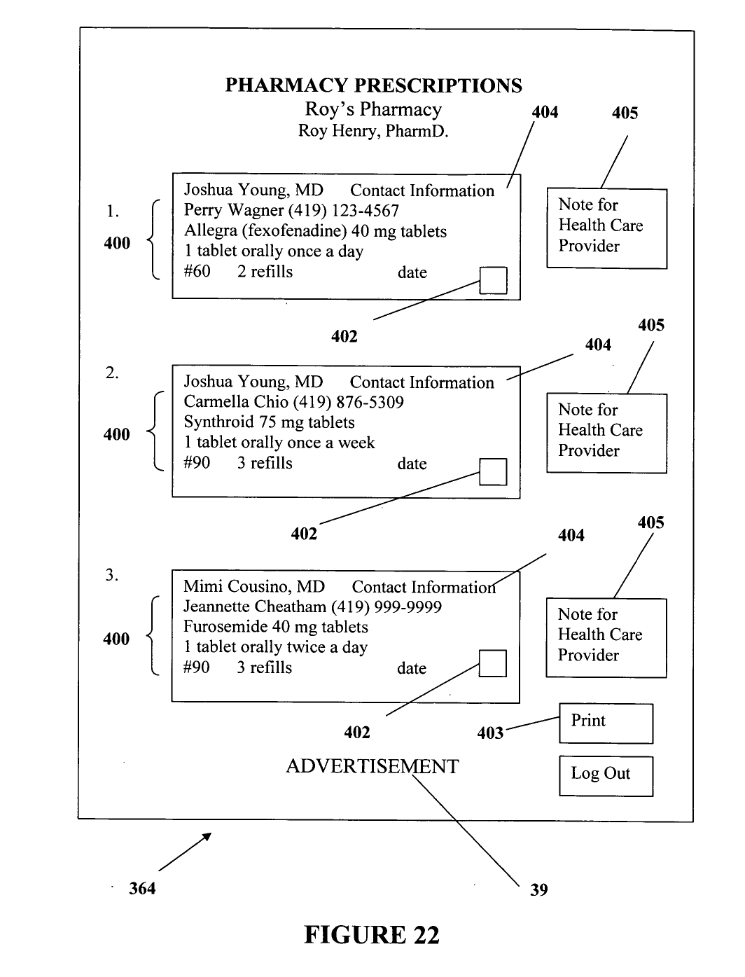

Thereafter, the prescription may be electronically submitted, with an electronic signature 358, to the pre-selected pharmacy. The term electronically submitted is intended to include faxing and e-mailing of the prescription to the pharmacy and, also saving the prescription within the system for viewing by the pharmacist. Options 361, 362 may be selected for sending the prescription via e-mail or facsimile to the pharmacy. As another option, the prescription may be submitted 363, with an electronic signature, for viewing by the pharmacist on a pharmacy prescriptions window 364 (FIG. 22). The prescription may also be printed 365 in hardcopy form for signature by the healthcare provider and then delivered to the pharmacy by conventional means such as, for example, by having the patient carry it with him to the pharmacy. Regardless of the method used to transmit the prescription to the pharmacy, the prescription is automatically saved to the system.

Referring to FIG. 21, additional information may also be provided through the prescription window 320 to assure the healthcare provider that the prescription is proper. For example, the selectable options may be provided that will cause windows (not shown) to be displayed for viewing, entering, storing and/or changing data relating to the patient's indications 380, as such dosing for a patient and starting doses; pregnancy classification 382; metabolism 384, for example how a dose should be adjusted for a patient with renal insufficiency; drug interactions 386, wherein a data base is linked to that lists possible drug interactions for the prescribed medication; and allergies 387.

The healthcare provider may use the medication system for submitting a prescription to the pharmacy even when the patient doesn't make the request through the system, such as when the patient calls the healthcare provider's office with a refill request or during an office appointment. The healthcare provider logs-on to access the patient's account and opens the medication window 72 (FIG. 6). Thereafter, the healthcare provider selects the options medication name 108 and then request a refill 244, as illustrated by FIG. 16. The medication system, identifying the user as a healthcare provider via his log-in information, displays the prescription window 320 (FIG. 21) for entry of prescription refill data, as described above.

When the medication is not listed in the medication page 72 (FIG. 6), such as when a new medication is being prescribed, the healthcare provider may select the add medication option 83. The medication system, identifying the user as a healthcare provider, causes the prescription window 320 to open wherein the healthcare provider may enter the medication information in the manner as previously described in relation to FIG. 21. The system will automatically store the particulars of the healthcare provider who prescribed the medication for display when a user selects the option who prescribed this medication 238 (FIG. 16).

The pharmacist may use the medication system to receive prescriptions from healthcare providers. In addition to prescriptions e-mailed and faxed to the pharmacy by means of the medication system, the system may also display prescription in a prescriptions window 364, as illustrated by FIG. 22.

To view and obtain the prescriptions, the pharmacist first accesses the medication system by logging into the system (FIG. 4). The system, recognizing the pharmacist via his log-in, provides the second log-in page 80, wherein the pharmacist may select the option refill requests 82 (FIG. 5). The system, differentiating the pharmacist, via his log-in, from a patient or healthcare provider classification, displays prescriptions sent by various healthcare providers in the pharmacy prescriptions window 364. The displayed prescriptions include all the necessary prescription information 400 as submitted by the healthcare provider. The prescription information may be printed on a bottle label by selecting the desired prescription 402, then selecting print 403. Additional information may also be provided, such as the healthcare provider contact information 404. It is also contemplated that the system may be configured to track when prescriptions are received and filled.

If the pharmacist has a question or concern regarding the prescription, he may leave a note for the healthcare provider by selecting the option pharmacist note 405. This option 405 causes a window to open wherein the pharmacist may enter his message. The system will save the message and display the same, along with the prescription information as originally sent, on the refills requested window 286 (FIG. 19), for the healthcare provider's review.

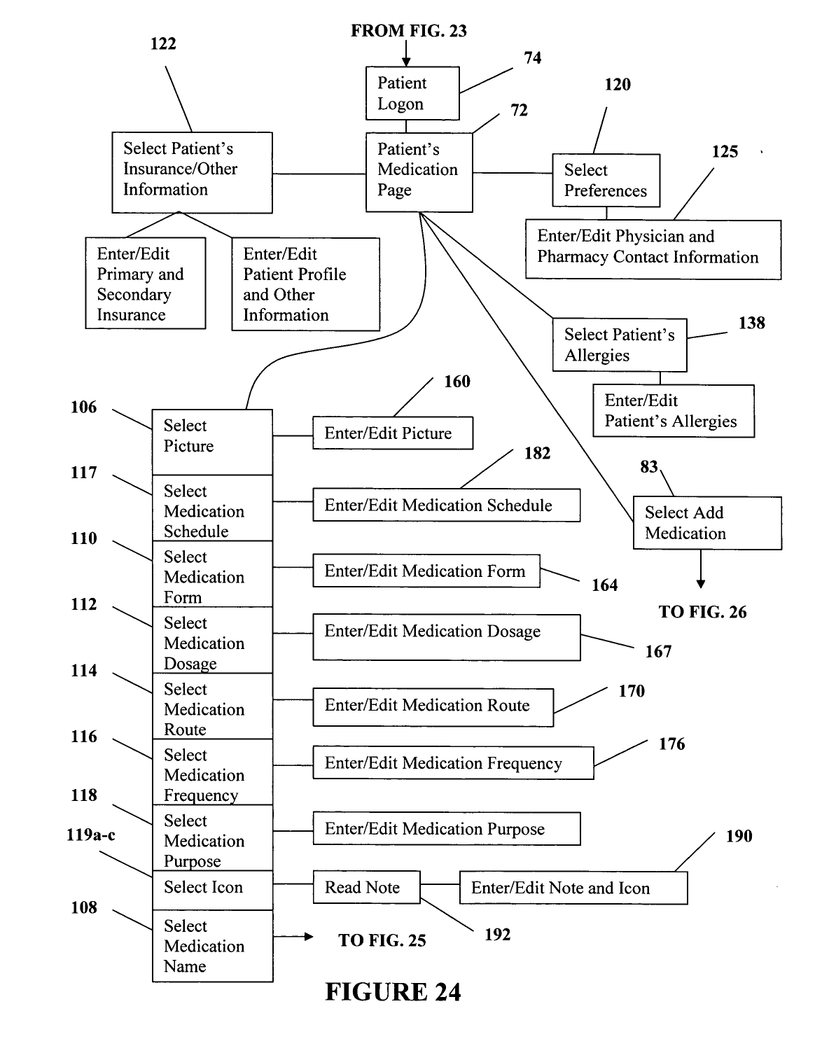

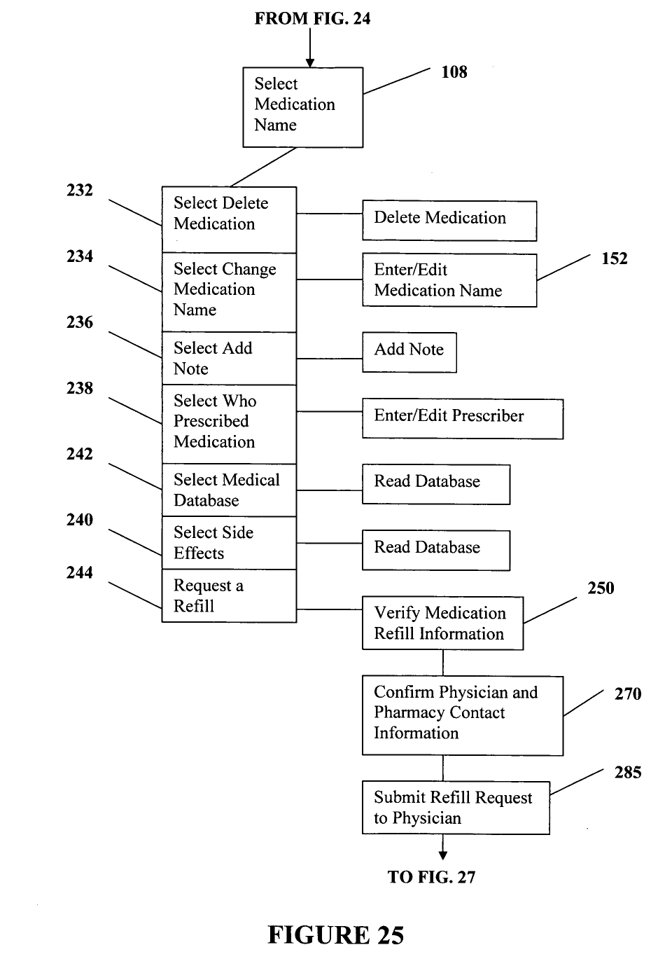

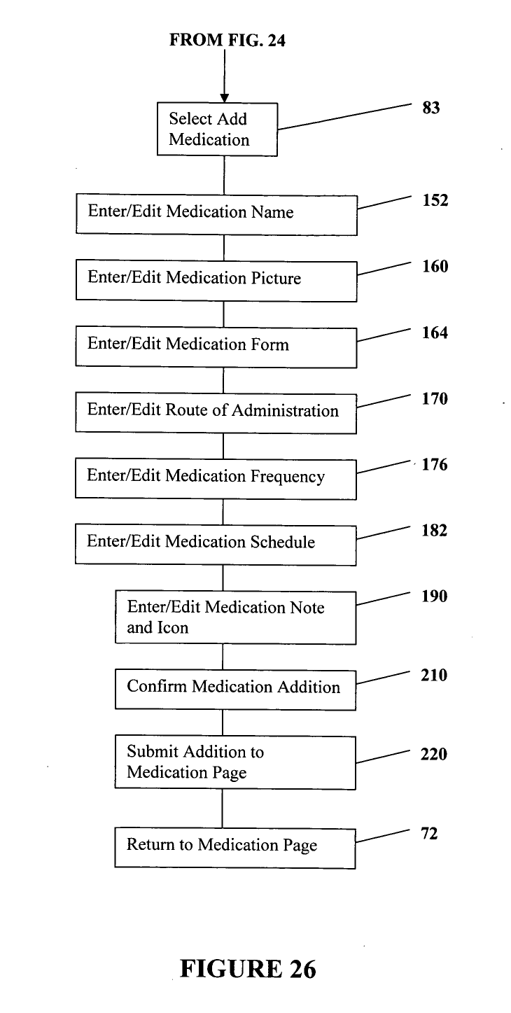

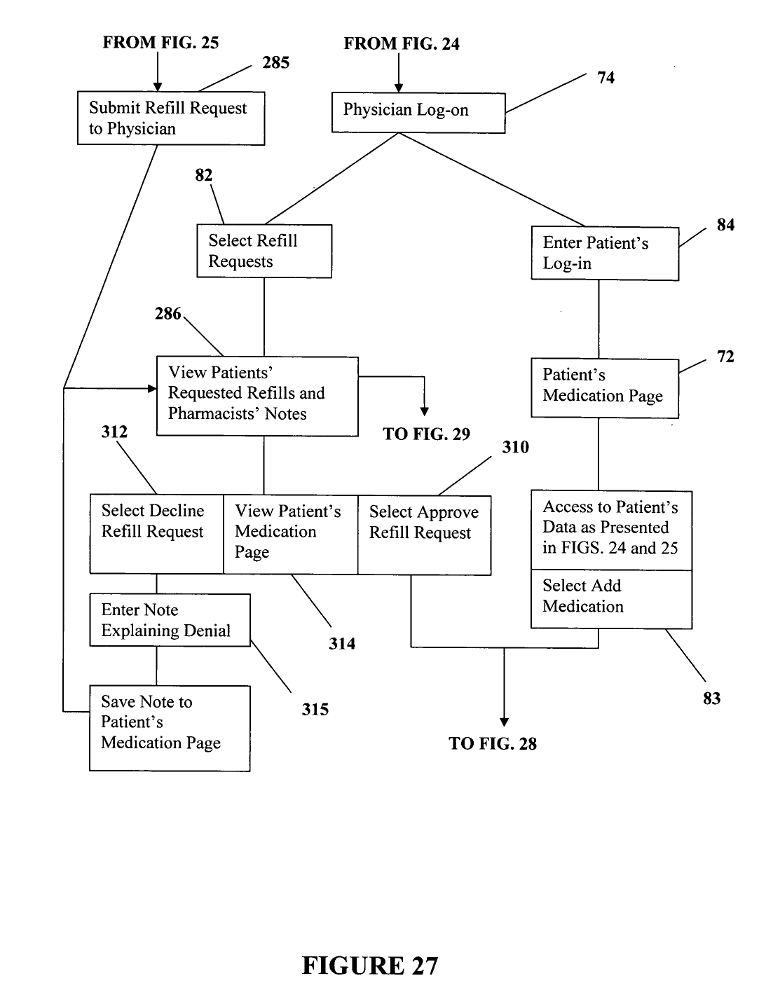

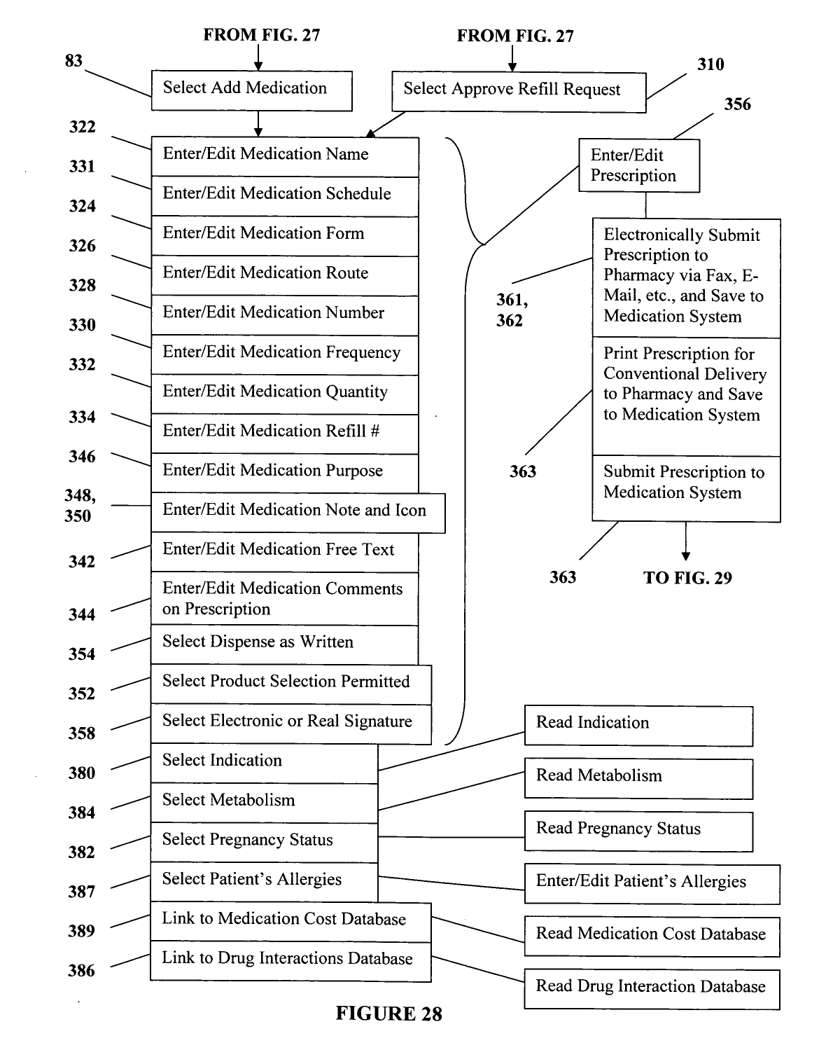

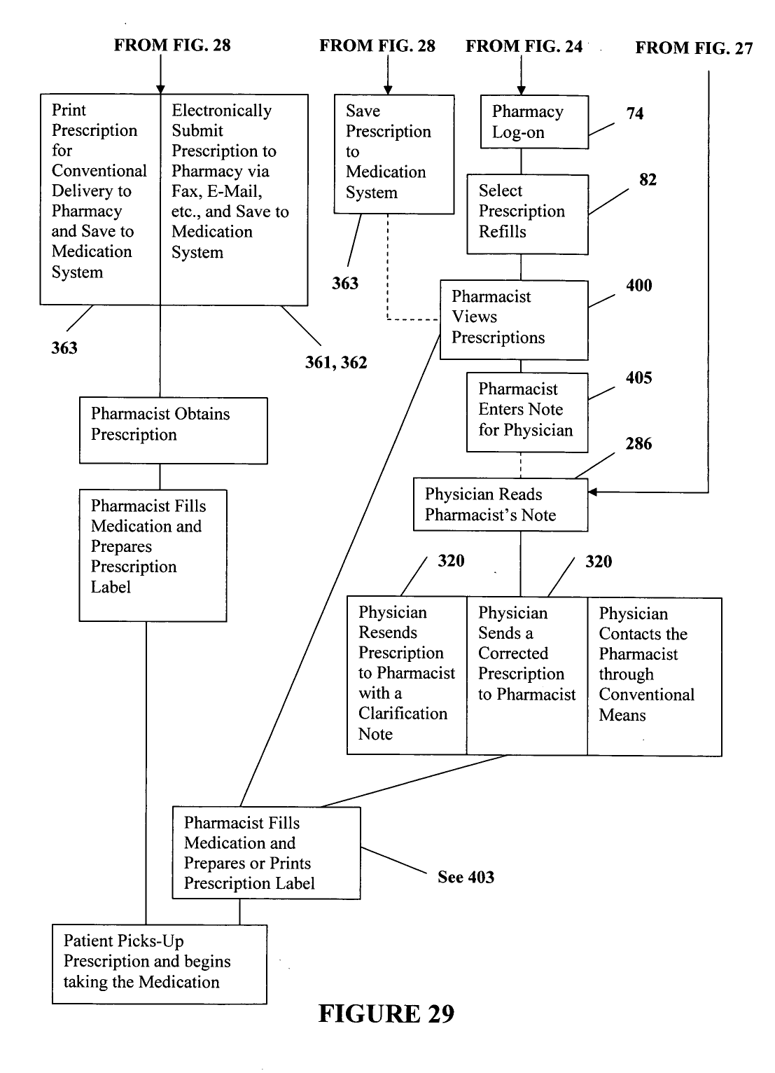

Referring to FIGS. 23-29, a simplified block diagram generally illustrates the previously described aspects of the medication system. Like reference numbers from FIGS. 23-29 correlate to like reference numbers in the remaining figures and associated description. It is noted that not every previously discussed option, nor every connector line, is illustrated in FIGS. 23-29, as it is intended that these Figures provide a general overview of the medication system. For example, it is to be understood that the medication page 72 (FIG. 24) may be returned to as an option from most locations within the system and, as such, these lines are not shown in FIGS. 23-29.

Referring to FIG. 30, in an embodiment of the medication system, the medication module 44 comprises one or more computer programs which acquire medication-related data, store and archive the data, manipulate the data, and formulate outputs which may be viewed by a user and queried by the system administrator. The medication module 44 preferably resides within the system memory device 410 of a computer system 412, which may, optionally, be an application server, a web server, a file server, or a database server. The system memory device 410 may include a random-access memory (RAM) and a read-only memory (ROM). The system memory device 410 may also include other types of memory, such as programmable read-only memory (PROM), erasable programmable read-only memory (EPROM), and electrically erasable programmable read-only memory (EEPROM). The system memory device 410 also preferably includes an operating system 414 that executes on a central processor 416. The central processor 416 may be, for example, a microprocessor. Suitable examples of microprocessors include, but are not limited to, those manufactured by Advanced Micro Devices, Inc. (Sunnyvale, Calif.), Intel Corporation (Santa Clara, Calif.), Motorola, Inc. (Schaumburg, Ill.), International Business Machines Corp. (Armonk, N.Y.), and Transmeta Corp. (Santa Clara, Calif.). The central processor 416 may include an arithmetic logic unit (ALU), which performs arithmetic and logic operations, and a control unit, which extracts instructions from the system memory device 410. The operating system 414 may include a set of instructions which control the internal functions of the computer system 412. For example, the operating system 414 may recognize input from input devices, send output to output devices, keep track of directories and files, and control various peripheral devices. Suitable examples of operating systems 414 include, but are not limited to, those manufactured by Microsoft Corporation (Redmond, Wash.), Apple Computer, Inc. (Cupertino, Calif.), and Sun Microsystems, Inc. (Palo Alto, Calif). A system bus 418 may communicate signals, such as address signals, data signals, and control signals, between the system memory device 410, the central processor 416, and one or more peripheral ports 420. The system memory device 410 may also contain an application program 422 and a basic input/output system (BIOS) 424. The application program 422 cooperates with the operating system 414 and the one or more peripheral ports 420 to provide a graphical user interface (GUI) 423. The GUI 423 typically includes a combination of signals communicated along a keyboard port 430, a mouse port 432, a monitor port 434, and one or more drive ports 438. The BIOS 424 may interpret requests from the operating system 414 and interface with such ports to execute the requests. Accordingly, suitable input/output devices include a keyboard, a mouse, a monitor, a printer, a plotter, speakers; etc.

The systems, methods, programs, and processes described in relation to the present invention are not limited to any particular computer system. The computer system 412 may be a single device, or it may be a plurality of devices working in concert. The computer system 412 may take the form of a hand-held digital computer, a personal computer, a workstation, a server, a mainframe computer, and a supercomputer.

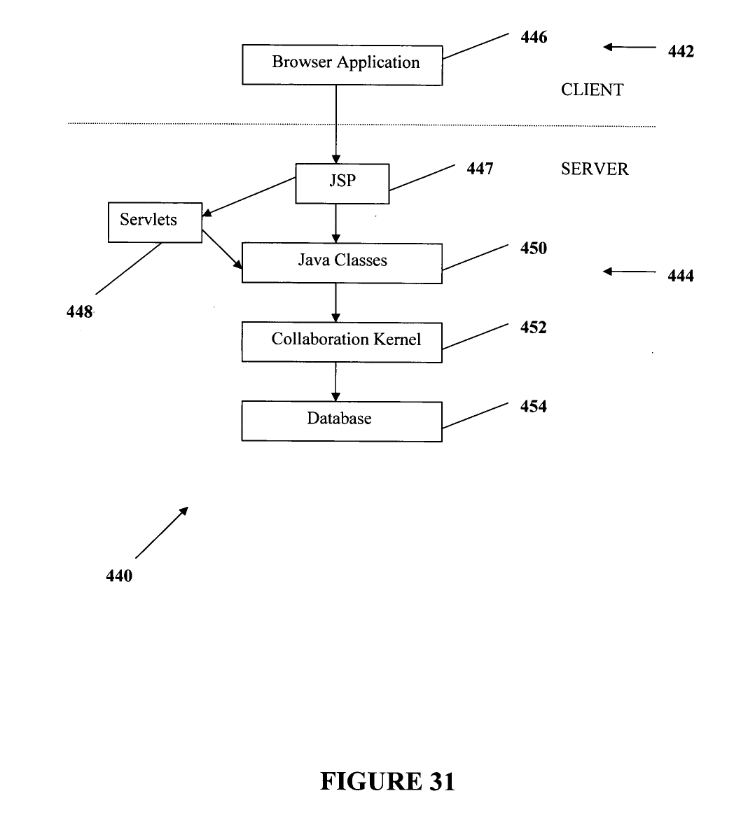

Referring to FIG. 31, in one embodiment, a system architecture 440 for the medication system 40 (FIG. 3) for data management of patients' medications includes a remote user/client portion 442 in communication with a server portion 444. The client portion 442 may include a browser application 446, such as a Hypertext Markup Language (HTML) or Extensible Markup Language (XML) browser. The medication system is preferably set up such that web pages have limited graphics content, allowing remote users connecting via dial-up modems or the like to download the pages rapidly. The speed of the system may also be increased by caching large files, such as by storing cached data in a cache server. The server portion 444 allows data to be published through applications such as active server pages (ASPs), Java server pages (JSPs) 447, and applets, such as Java applets and servlets 448. Further, the server portion 444 may include one or more Java classes 450 and a collaboration kernel 452. The collaboration kernel 452 interfaces the Java classes 450 or Java application with a relational database 454 for persistent storage. Finally, the system is set up such that it may communicate with external database software/applications.

As discussed above, functionally the medication system for managing medication information allows a remote user 42 (FIG. 3) to log into a globally-accessible system 40 and create and store a plurality of issues and risks. The globally-accessible system 40 preferably includes a web page which contains or is in communication with the medication module 44 (FIG. 30). The web page is preferably secure and may include a plurality of dynamic menus, drop-down lists, links, and the like displayed on a graphical user interface. Through the medication web page, healthcare providers, pharmacists, patients, or any other authorized remote users 42 may view information. The system may also be queried by a systems administrator. After a set of medication data has been created and stored, the medication module 44 is operable for attaching meta-data to the various data. The meta-data allows the data to be searched and identified. For example, the meta-data may be used to identify patients being prescribed a specific medication. As another example, the meta-data may be used to identify healthcare providers within a particular practice area. Once the criteria has been searched and identified, the information may be complied or used in a variety of ways. For example, an increase in prescriptions for a particular medication may be tracked. As another example, specific advertisements may be targeted towards an identified class for users.

In use, the foregoing system provides a data management system for management of a patient's medications and for facilitating information transfer between a patient, healthcare provider and pharmacist.

The system allows for the healthcare provider to obtain a comprehensive list of the patient's medications by having the patient print his list from the medication system prior to presenting to the healthcare provider, or where the patient fails to bring his list, or is unable to provide the list due to an acute care situation, the healthcare provider may obtain the same by logging onto the medication system.

By having available a complete and current list of the patient's medications, the healthcare provider reduces the amount of time that was traditionally needed for reconstructing the same by refreshing a patient's memory, looking through prior charts, looking through sacks of medicine, or contacting family members and other healthcare providers. The benefits of having a comprehensive and up-to-date patient's medication list are further exemplified in an acute care setting, such as during an emergency room visit, where the patient may not be able to provide information regarding his use of prescriptions.

The medication system also has utility in aiding the healthcare provider during patient examination by providing access to information necessary for proper diagnosis and treatment. For example, the system allows for the healthcare provider to quickly review the patient's medications and look-up related adverse side-effects. As such, the healthcare provider will have at his disposal potential adverse drug interactions and whether a symptom may be a side-effect of a particular medication rather than a separate condition requiring treatment via an additional medication. The system further allows for the healthcare provider to check for a listing of substances to which the patient is allergic.

After examining the patient, the healthcare provider may enter a new medication into the system and prepare a prescription for the new medication or for a refill. The healthcare provider may also make other desired changes to the patient's medication list. For example, the healthcare provider may delete medications on the list that are no longer necessary or note instructions for certain prescriptions. As such, at the time of diagnosis and prescribing, the patient's medication list may be updated.

The patient may also utilize the medication system to make a request to refill a current medication. Using the system, the healthcare provider may approve the refill and submit the prescription to a pharmacy.

By having the prescription for new and refill medications being prepared through the system, the patient may present to the pharmacy without delay. Moreover, by having the medication list kept current, the patient may immediately present to another physician without concern of whether he remembers the particulars of his newly prescribed medication or whether traditional correspondence between the healthcare providers was timely and accurate.

The medication system may also provide the pharmacist with a more accurate prescription. That is, the health care provider may print, e-mail, fax, or store within the system, a patient's prescription for the pharmacist to fill. As such, traditional communication errors such as illegible handwriting and difficult to understand speech, as communicated though a telephone or voice message, are eliminated. Moreover, the medication system removes the conventional step of the pharmacist answering the phone or copying information from an answering machine.

After picking-up his medications, the patient may access the medication system to refresh his memory as to particulars of the medications such as their purpose, dosage and frequency, and other additional instructions and notes. The patient may also link to related health care sites to obtain additional information. As such, the patient being armed with knowledge of his treatment plan gains confidence and a greater ability to properly follow and maintain his treatment program.

The foregoing provides a detailed description of exemplary embodiments of the present invention. Although a medication system for data management of a patient's medications has been described with reference to preferred embodiments and examples thereof, other embodiments and examples may perform similar functions and/or achieve similar results. All such equivalent embodiments and examples are within the spirit and scope of the present invention and are intended to be covered by the following claims.

That which is claimed is:

1. A computerized method for data management of a patient's medications, comprising the steps of:
providing a computerized system;
storing a classification of a user within the computerized system;
storing a name of a medication within the computerized system;
allowing the medication name within the system to be changed by the user wherein the user is classified as being a patient; and
requesting a prescription by the patient to a user that is classified as being a healthcare provider.

2. The computerized method of claim 1, further comprising the step of preparing a prescription by the healthcare provider.

3. The computerized method of claim 2 further comprising the step of electronically submitting the prescription to a user classified as a pharmacist.

4. The computerized method of claim 1 further comprising the steps of storing a form of the medication and storing a frequency at which the medication is to be taken.

5. The computerized method of claim 4 further comprising the steps of allowing the patient to change the medication form and the frequency.

6. The computerized method of claim 5 further comprising the steps of storing a route of administration of the medication and a purpose of the medication.

7. The computerized method of claim 6 further comprising the steps of allowing the patient to change the medication route of administration and the purpose.

8. The computerized method of claim 1 further comprising the step of attaching meta-data to the classification of the user.

9. The computerized method of claim 8 further comprises the steps of searching for and identifying the user based on the user's classification by using meta-data and displaying a predetermined advertisement based on the user's classification.

10. The computerized method of claim 9 further comprising the step of attaching meta-data to the name of the medication.

11. The computerized method of claim 10 further comprising the step of searching for and identifying the name of the medication using meta-data and displaying a predetermined advertisement to the user that has the name of the medication stored.

12. The computerized method of claim 1 further comprising the step of accessing the system by a medication card.

13. The computerized method of claim 1 wherein the system is globally-accessible and web-based.

14. A globally-accessible, electronic method for data management of a patient's medications, comprising the steps of:
providing an electronic system;
storing a classification of a user within the electronic system wherein the classification includes the classes of patient, healthcare provider and pharmacist;
storing data within the system by the patient wherein the data includes a name of a medication, a contact information of a healthcare provider and a contact information of a pharmacist;
allowing the patient to change data within the system;
allowing the patient to electronically request to the healthcare provider for a prescription;
preparing a prescription by the healthcare provider; and
allowing the healthcare provider to electronically submit the prescription to the pharmacist.

15. The electronic method of claim 14 further comprising the steps of searching for and identifying data within the system, associating an advertisement with the identified data, and displaying the advertisement.

16. The electonic method of claim 14 further wherein the data further includes a form of the medication, a route of administration of the medication, an image of the medication, and a purpose of the medication.

17. The electronic method of claim 14 further comprising the step of the healthcare provider denying the request for the prescription.

18. The electronic method of claim 17 further comprising the step of the healthcare provider electronically communicating the denial of the prescription to the patient.

19. The electronic method of claim 14 further comprising the step of accessing the system by a medication card.

20. A computerized system for data management of a patent's medications, comprising:
a data storage device for storing a patient's medication data wherein the data includes a name of the medication, a form of the medication, a route of medication administration, a purpose of the medication, a contact information of the patient's healthcare provider, and a contact information of the patient's pharmacist;
wherein the patient and the healthcare provider can change the medication data and enter new data into said system;
wherein said system is configured so that the patient may electronically make a request to the healthcare provider for a prescription;
wherein the healthcare provider may electronically prepare a prescription and submit a prescription to the pharmacist; and
a medication card for accessing said system.
